(19) United States
(12) Patent Application Publication
(10) Pub. No.: US 2017/0225429 A1
(43) Pub. Date: Aug. 10, 2017

(54) PREPREGS, CORES AND COMPOSITE ARTICLES INCLUDING SYNERGISTIC AND COMPOUNDED FLAME RETARDANT MATERIALS

(71) Applicants: Ziniu Yu, Forest, VA (US); Ruomiao Wang, Forest, VA (US); Yankai Yang, Lynchburg, VA (US); Mark O Mason, Covington, VA (US)

(72) Inventors: Ziniu Yu, Forest, VA (US); Ruomiao Wang, Forest, VA (US); Yankai Yang, Lynchburg, VA (US); Mark O Mason, Covington, VA (US)

(21) Appl. No.: 15/397,993

(22) Filed: Jan. 4, 2017

Related U.S. Application Data
(60) Provisional application No. 62/275,044, filed on Jan. 5, 2016.

(51) Int. Cl. B32B 5/18

(52) U.S. Cl. CPC B32B 5/18; B32B 2307/3065

(57) ABSTRACT

Prepregs, core layers and composite articles comprising one or more flame retardant materials are described. In some instances, a thermoplastic composite article comprises a porous core layer comprising a plurality of reinforcing fibers, a first thermoplastic material, and a second thermoplastic material from a compounded flame retardant material comprising the second thermoplastic material and a flame retardant material. In other instances, a thermoplastic composite article comprises a porous core layer comprising a plurality of reinforcing fibers, a first thermoplastic material, expandable graphite materials and a group II metal hydroxide or a group III metal hydroxide.

### PRIORITY APPLICATION

This application is related to and claims priority to and the benefit of U.S. Provisional Application No. 62/275,044 filed on Jan. 5, 2016, the entire disclosure of which is hereby incorporated herein by reference.

### TECHNOLOGICAL FIELD

This application is related to composite articles that comprise one or more flame retardants, e.g., one or more compounded flame retardant materials or mixtures of flame retardant materials. In certain configurations, composite articles that include a thermoplastic core comprising a first thermoplastic material, a plurality of reinforcing fibers and a second thermoplastic material from a compounded flame retardant material are described.

### BACKGROUND

Articles for automotive and building materials applications typically are designed to meet a number of competing and stringent performance specifications.

### SUMMARY

Certain configurations of the prepregs, cores and composite articles described herein provide desirable attributes including, but not limited to, flame retardancy, the ability to color or dye the article to any color, enhanced processability and enhanced usability.

In a first aspect, a thermoplastic composite article comprises a porous core layer comprising a plurality of reinforcing fibers, a thermoplastic material, and a compounded flame retardant material.

In certain embodiments, the compounded flame retardant material comprises a hydroxide material compounded with a thermoplastic material. In some instances, the hydroxide material comprises a group II metal hydroxide, and wherein the compounded flame retardant material is present in an effective amount for the article to meet a Class A standard as tested by ASTM E84 dated 2009. In other embodiments, the thermoplastic material of the compounded flame retardant material comprises a common thermoplastic material as present in the porous core layer. In some configurations, the thermoplastic material of each of the porous core layer and the compounded flame retardant is independently selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof. In certain instances, the thermoplastic material of the compounded flame retardant material comprises a different thermoplastic material from the thermoplastic material. In some examples, the thermoplastic material of each of the porous core layer and the compounded flame retardant is independently selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof, wherein the thermoplastic material selected for the thermoplastic material of the core layer is different than the thermoplastic material present in the compounded flame retardant material. In other examples, the porous core layer provides flame retardancy and is halogen free. In further examples, the article comprises a flame retardant agent in the porous core layer, in which the flame retardant agent comprises at least one of N, P, As, Sb, Bi, S, Se, or Te. In some embodiments, the article comprises a lofting agent in the porous core layer.

In another aspect, a thermoplastic composite article comprises a porous core layer comprising a web of open cell structures comprising random crossing over of reinforcing fibers held together by a first thermoplastic material and a second thermoplastic material from a compounded flame retardant material comprising the second thermoplastic material and a flame retardant material.

In certain embodiments, the compounded flame retardant material comprises a hydroxide material compounded with the second thermoplastic material. In other embodiments, the hydroxide material comprises a group II metal hydroxide, and wherein the compounded flame retardant material is present in an effective amount for the article to meet a Class A standard as tested by ASTM E84 dated 2009. In certain examples, the second thermoplastic material of the compounded flame retardant material comprises the same thermoplastic material as the first thermoplastic material. In further embodiments, the first thermoplastic material and the second thermoplastic material independently comprise at least one of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof. In other examples, the first thermoplastic material and the second thermoplastic material comprise different thermoplastic materials. In some examples, the plurality of reinforcing fibers comprise at least one of glass fibers, aramid fibers, graphite fibers, carbon fibers, inorganic mineral fibers, metal fibers, metalized synthetic fibers, and metallized inorganic fibers. In certain examples, the porous core layer provides flame retardancy and is halogen free. In some embodiments, the article comprises an additional flame retardant agent comprises at least one of N, P, As, Sb, Bi, S, Se, or Te. In other examples, the article comprises a lofting agent in the porous core layer.

In an additional aspect, a thermoplastic composite sheet comprises a porous core layer comprising a plurality of reinforcing fibers, a first thermoplastic material, and a compounded flame retardant comprising a second thermoplastic material, and a skin disposed on at least one surface of the porous core layer.

In certain embodiments, the sheet comprises an additional porous core layer disposed between the porous core layer and the skin. In other embodiments, the additional porous core layer comprises a plurality of reinforcing fibers, a first thermoplastic material, and a compounded flame retardant comprising a second thermoplastic material. In some examples, the compounded flame retardant in the porous core layer and the additional porous core layer are the same. In other embodiments, the compounded flame retardant in the porous core layer and the additional porous core layer are different. In certain examples, the porous core layer provides flame retardancy and is halogen free. In some configurations, the sheet comprises an additional flame retardant agent comprises at least one of N, P, As, Sb, Bi, S, Se, or Te. In other examples, the compounded flame retardant comprises a group II metal hydroxide, and wherein the compounded flame retardant material is present in an effective amount for the sheet to meet a Class A standard as tested by ASTM E84. In certain embodiments, the sheet comprises a lofting agent in the porous core layer. In other embodiments, the skin comprises a compounded flame retardant material.

In another aspect, a thermoplastic composite sheet comprises a porous core layer comprising a web of open cell structures comprising random crossing over of reinforcing fibers held together by a first thermoplastic material and a second thermoplastic material from a compounded flame retardant material comprising the second thermoplastic material and a flame retardant material, and a skin disposed on at least one surface of the porous core layer.

In certain configurations, the sheet comprises an additional porous core layer disposed between the porous core layer and the skin. In other configurations, the additional porous core layer comprises a plurality of reinforcing fibers, a first thermoplastic material, and a compounded flame retardant comprising a second thermoplastic material. In some embodiments, the compounded flame retardant in the porous core layer and the additional porous core layer are the same. In certain examples, the compounded flame retardant in the porous core layer and the additional porous core layer are different. In other examples, the porous core layer provides flame retardancy and is halogen free. In some instances, the sheet comprises an additional flame retardant agent comprises at least one of N, P, As, Sb, Bi, S, Se, or Te. In other instances, the compounded flame retardant comprises a group II metal hydroxide, and wherein the compounded flame retardant material is present in an effective amount for the sheet to meet a Class A standard as tested by ASTM E84. In some examples, the sheet comprises a lofting agent in the porous core layer. In other examples, the skin comprises a compounded flame retardant material.

In an additional aspect, a thermoplastic composite sheet comprising a porous core layer comprising a web of open cell structures comprising random crossing over of reinforcing fibers held together by a first thermoplastic material and a second thermoplastic material from a compounded flame retardant material, the compounded flame retardant material further comprising a group II metal hydroxide, and a skin disposed on at least one surface of the porous core layer, in which the group II metal hydroxide is present in an effective amount in the sheet so the sheet meets a Class A standard as tested by ASTM E84 is provided.

In certain embodiments, the sheet comprises an additional porous core layer disposed between the porous core layer and the skin. In other embodiments, the additional porous core layer comprises a plurality of reinforcing fibers, a first thermoplastic material, and a compounded flame retardant comprising a second thermoplastic material. In some examples, the compounded flame retardant in the porous core layer and the additional porous core layer are each the same divalent hydroxide flame retardant material. In some embodiments, the compounded flame retardant in the additional porous core layer is different than the divalent hydroxide flame retardant material. In certain examples, the porous core layer provides flame retardancy and is halogen free. In some examples, the sheet comprises an additional flame retardant agent in the porous core layer, in which the additional flame retardant agent comprises at least one of N, P, As, Sb, Bi, S, Se, or Te. In other examples, the group II metal hydroxide of the compounded flame retardant comprises at least one of calcium hydroxide and magnesium hydroxide. In some instances, the sheet comprises a lofting agent in the porous core layer. In other instances, the skin comprises a compounded flame retardant material.

In another aspect, a method comprises combining a first thermoplastic material, reinforcing fibers and a compounded flame retardant material comprising a flame retardant material and a second thermoplastic material to form an agitated aqueous foam, disposing the agitated aqueous foam onto a wire support, evacuating the water to form a web, heating the web to a first temperature at or above the melting temperature of the first thermoplastic material, and applying pressure to the web to provide a thermoplastic composite sheet.

In some instances, the combining step comprises mixing the first thermoplastic material, reinforcing fibers and compounded flame retardant material until a homogeneous agitated aqueous foam is formed. In certain configurations, the method comprises heating the web to a second temperature, greater than the first temperature, at or above the melting temperature of the second thermoplastic material of compounded flame retardant material. In other examples, the method comprises heating the web using convection heating. In certain instances, the method comprises applying pressure to the heated thermoplastic composite sheet. In some examples, the method comprises heating the thermoplastic composite sheet using radiant heating. In other embodiments, the method comprises disposing additional compound flame retardant material on a surface of the thermoplastic composite sheet. In some instances, the method comprises configuring the compounded flame retardant material to comprise a divalent metal hydroxide. In certain embodiments, the method comprises coupling the thermoplastic composite sheet to a skin. In other instances, the method comprises configuring the amount of flame retardant material from the compounded flame retardant material to provide a Class A standard as tested by ASTM E84 for the composite sheet.

In another aspect, a method comprises combining a first thermoplastic material and reinforcing fibers to form an agitated aqueous foam, disposing the agitated aqueous foam onto a wire support, evacuating the water to form a web, heating the web to a first temperature at or above the melting temperature of the first thermoplastic material, adding a compounded flame retardant material to the heated web to provide a composite web, the compounded flame retardant material comprising a flame retardant material and a second thermoplastic material, and applying pressure to the composite web to provide a thermoplastic composite sheet.

In certain embodiments, the method comprises configuring the compounded flame retardant material to comprise a group II metal hydroxide. In other embodiments, the method comprises configuring the second thermoplastic material to be the same as the first thermoplastic material so the second thermoplastic material melts when the compound flame retardant is added to the heated web. In some examples, the method comprises heating the composite web to a second temperature, greater than the first temperature, at or above the melting temperature of the second thermoplastic material of compounded flame retardant material. In certain instances, the method comprises heating the web using convection heating. In further examples, the method comprises heating the thermoplastic composite sheet using radiant heating. In some instances, the method comprises disposing additional compound flame retardant material on a surface of the thermoplastic composite sheet. In other examples, the method comprises adding a lofting agent to the agitated aqueous foam. In some examples, the method comprises coupling the thermoplastic composite sheet to a skin. In certain configurations, the method comprises configuring the amount of flame retardant material from the compounded flame retardant material to provide a Class A standard as tested by ASTM E84 for the composite sheet.

In an additional aspect, a method comprises combining a first thermoplastic material and reinforcing fibers to form an agitated aqueous foam, disposing the agitated aqueous foam onto a wire support, evacuating the water to form a web, adding a compounded flame retardant material to the web, the compounded flame retardant material comprising a flame retardant material and a second thermoplastic material, heating the web to a first temperature at or above the melting temperature of the first thermoplastic material and the second thermoplastic material, and applying pressure to the composite web to provide a thermoplastic composite sheet.

In certain instances, the method comprises configuring the compounded flame retardant material to comprise a group II metal hydroxide. In other examples, the method comprises configuring the second thermoplastic material to be the same as the first thermoplastic material. In some embodiments, the method comprises configuring the group II metal hydroxide to comprise magnesium hydroxide and configuring the second thermoplastic material to comprise polypropylene. In certain examples, the method comprises heating the web using convection heating. In other embodiments, the method comprises heating the thermoplastic composite sheet using radiant heating. In certain configurations, the method comprises disposing additional compound flame retardant material on a surface of the thermoplastic composite sheet. In some embodiments, the method comprises adding a lofting agent to the agitated aqueous foam. In certain instances, the method comprises coupling the thermoplastic composite sheet to a skin. In some examples, the method comprises configuring the amount of flame retardant material from the compounded flame retardant material to provide a Class A standard as tested by ASTM E84 for the composite sheet.

In another aspect, a prepreg comprising a web of open cell structures formed by a plurality of reinforcing fibers held together by a first thermoplastic material and a second thermoplastic material from a compounded flame retardant material is described. In certain instances, the compounded flame retardant material comprises a group II metal hydroxide. In other instances, each of the first thermoplastic material and a second thermoplastic material is independently selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

In an additional aspect, a thermoplastic article comprises a porous core layer comprising a web of open cell structures formed by a plurality of reinforcing fibers held together by a first thermoplastic material and a second thermoplastic material from a compounded flame retardant material comprising a flame retardant and the second thermoplastic material, in which the flame retardant material is present in an effective amount to provide a Class A standard as tested by ASTM E84. In certain configurations, the compounded flame retardant material comprises a group II metal hydroxide. In other configurations, each of the first thermoplastic material and a second thermoplastic material is independently selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof. In additional configurations, the group II metal hydroxide is magnesium hydroxide that is present at 40% by weight or more in the article.

In another aspect, a thermoplastic article comprises a porous core layer comprising a web of open cell structures formed by a plurality of reinforcing fibers held together by a first thermoplastic material and a second thermoplastic material from a compounded flame retardant material, and a skin disposed on at least one surface of the porous core layer, in which the flame retardant material is present in an effective amount to permit the article to meet the ASTM E84 class A standard. In certain instances, the compounded flame retardant material comprises a group II metal hydroxide. In other instances, each of the first thermoplastic material and a second thermoplastic material is independently selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof. In some embodiments, the group II metal hydroxide is magnesium hydroxide that is present at 40% by weight or more in the article.

In an additional aspect, a method of producing a thermoplastic composite article comprising a plurality of reinforcing fibers, a thermoplastic material and a compounded flame retardant material comprising a flame retardant material compounded with a second thermoplastic material by heating a mixture of the reinforcing fibers, the thermoplastic material and the compounded flame retardant material to a first temperature above a melting point of the first and second thermoplastic materials is described. In certain instances, the method comprises selecting the first and second thermoplastic materials to be the same thermoplastic material. In other instances, the method comprises selecting the flame retardant material to be a group II metal hydroxide. In some configurations, the method comprises applying pressure to the heated mixture to form the thermoplastic composite article.

In another aspect, a method of producing a thermoplastic composite article comprising a plurality of reinforcing fibers and a thermoplastic material by heating a mixture of the reinforcing fibers and the thermoplastic material to a first temperature above a melting point of the first thermoplastic materials, and adding a solid compounded flame retardant material to the melted first thermoplastic material and heated reinforcing fibers, the compounded flame retardant material comprising a flame retardant material compounded with a second thermoplastic material is provided. In certain instances, the method comprises heating the thermoplastic material, the reinforcing fibers and the added compounded flame retardant material to a temperature above the melting temperature of the second thermoplastic material. In other configurations, the method comprises applying pressure to the heated mixture to form the thermoplastic composite article.

In an additional aspect, a thermoplastic composite article comprises a porous core layer comprising a plurality of reinforcing fibers, a thermoplastic material, expandable graphite materials and a group II metal hydroxide or a group III metal hydroxide.

In some examples, the group II metal hydroxide or group III metal hydroxide is compounded with a thermoplastic material. In other examples, the thermoplastic material of each of the porous core layer and the compounded flame retardant is independently selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof. In some embodiments, the thermoplastic material of the compounded flame retardant material comprises a different thermoplastic material from the thermoplastic material. In certain examples, the thermoplastic material of each of the porous core layer and the compounded flame retardant is independently selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof, wherein the thermoplastic material selected for the thermoplastic material of the core layer is different than the thermoplastic material present in the compounded flame retardant material. In other examples, the expandable graphite material is present at less than 5 weight percent and the group II metal hydroxide or the group III metal hydroxide is present in an effective amount to permit the article to meet both a non-oil soaked and an oil-soaked SAE self-extinguishing test as measured using SAE J369 method (REV. November 2007). In some examples, the group II metal hydroxide or the group III metal hydroxide is present at 9 weight percent or more. In certain embodiments, the porous core layer provides flame retardancy and is halogen free. In some instances, the article comprises a flame retardant agent in the porous core layer, in which the flame retardant agent comprises at least one of N, P, As, Sb, Bi, S, Se, or Te. In some examples, the article comprises a lofting agent in the porous core layer.

In another aspect, a thermoplastic composite article comprises a porous core layer comprising a web of open cell structures comprising random crossing over of reinforcing fibers held together by a first thermoplastic material, wherein the porous core layer further comprises expandable graphite materials and a group II metal hydroxide or a group III metal hydroxide and wherein the thermoplastic composite article meets a non-oil soaked and an oil-soaked SAE self-extinguishing test as measured using SAE J369 method (REV. November 2007).

In certain examples, the article comprises a compounded flame retardant material comprising a hydroxide material compounded with a second thermoplastic material. In some embodiments, the second thermoplastic material of the compounded flame retardant material comprises the same thermoplastic material as the first thermoplastic material. In some instances, the first thermoplastic material and the second thermoplastic material independently comprise at least one of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof. In some examples, the first thermoplastic material and the second thermoplastic material comprise different thermoplastic materials. In certain examples, the group II metal hydroxide comprises magnesium hydroxide. In some examples, the plurality of reinforcing fibers comprise at least one of glass fibers, aramid fibers, graphite fibers, carbon fibers, inorganic mineral fibers, metal fibers, metalized synthetic fibers, and metallized inorganic fibers. In certain embodiments, the porous core layer provides flame retardancy and is halogen free. In some examples, the article comprises an additional flame retardant agent comprising at least one of N, P, As, Sb, Bi, S, Se, or Te. In other examples, the article comprises a lofting agent in the porous core layer.

In another aspect, a thermoplastic composite sheet comprises a porous core layer comprising a plurality of reinforcing fibers, a first thermoplastic material, expandable graphite material and a group II metal hydroxide or a group III metal hydroxide, and a skin disposed on at least one surface of the porous core layer.

In certain examples, the sheet comprises an additional porous core layer disposed between the porous core layer and the skin. In some examples, the additional porous core layer comprises a plurality of reinforcing fibers, a second thermoplastic material, expandable graphite material and a group II metal hydroxide or a group III metal hydroxide. In certain instances, the first and second thermoplastic materials are the same. In some embodiments, the first and second thermoplastic materials are different. In other embodiments, the porous core layer provides flame retardancy and is halogen free. In some examples, the sheet comprises an additional flame retardant agent comprising at least one of N, P, As, Sb, Bi, S, Se, or Te. In some examples, the sheet comprises a compounded flame retardant comprising a group II metal hydroxide compounded with an additional thermoplastic material. In other examples, the sheet comprises a lofting agent in the porous core layer. In some embodiments, the skin comprises a compounded flame retardant material.

In an additional aspect, a thermoplastic composite sheet comprises a porous core layer comprising a web of open cell structures comprising random crossing over of reinforcing fibers held together by a first thermoplastic material, wherein the core layer comprises expandable graphite material and a group II metal hydroxide or a group III metal hydroxide in the open cell structures of the web, and a skin disposed on at least one surface of the porous core layer.

In some examples, the sheet comprises an additional porous core layer disposed between the porous core layer and the skin. In certain examples, the additional porous core layer comprises a plurality of reinforcing fibers, a second thermoplastic material, expandable graphite material and a group II metal hydroxide or a group III metal hydroxide. In some embodiments, the first and second thermoplastic materials are the same. In other embodiments, the first and second thermoplastic materials are different. In some instances, the porous core layer provides flame retardancy and is halogen free. In other examples, the sheet comprises an additional flame retardant agent comprising at least one of N, P, As, Sb, Bi, S, Se, or Te. In some examples, the sheet comprises a compounded flame retardant comprising a group II metal hydroxide. In other examples, the sheet comprises a lofting agent in the porous core layer. In some examples, the skin comprises a compounded flame retardant material.

In another aspect, a thermoplastic composite sheet comprises a porous core layer comprising a web of open cell structures comprising random crossing over of reinforcing fibers held together by a first thermoplastic material, wherein the core layer further comprises expandable graphite material and a group II metal hydroxide or a group III metal hydroxide in the open cell structures of the web, and a skin disposed on at least one surface of the porous core layer, in which the core layer comprises five weight percent or less expandable graphite materials and an effective amount of the group II metal hydroxide or the group III metal hydroxide so the sheet meets a non-oil soaked and an oil-soaked SAE self-extinguishing test as measured using SAE J369 method (REV. November 2007).

In certain examples, the sheet comprises an additional porous core layer disposed between the porous core layer and the skin. In other examples, the additional porous core layer comprises a plurality of reinforcing fibers, a first thermoplastic material, expandable graphite material and a group II metal hydroxide or a group III metal hydroxide. In some embodiments, the group II metal hydroxide or the group III metal hydroxide of the core layer and the group II metal hydroxide or the group III metal hydroxide of the additional porous core layer are each the same divalent hydroxide flame retardant material. In certain examples, the group II metal hydroxide or the group III metal hydroxide of the core layer and the group II metal hydroxide or the group III metal hydroxide of the additional porous core layer are different hydroxide materials. In some embodiments, the porous core layer provides flame retardancy and is halogen free. In other embodiments, the sheet comprises an additional flame retardant agent in the porous core layer, in which the additional flame retardant agent comprises at least one of N, P, As, Sb, Bi, S, Se, or Te. In some examples, the group II metal hydroxide of the flame retardant comprises at least one of calcium hydroxide and magnesium hydroxide. In some instances, the sheet comprises a lofting agent in the porous core layer. In other instances, the skin comprises a compounded flame retardant material.

In an additional aspect, a method comprises combining a first thermoplastic material, reinforcing fibers, expandable graphite materials and a group II metal hydroxide or a group III metal hydroxide to form an agitated aqueous foam, disposing the agitated aqueous foam onto a wire support, evacuating the water to form a web, heating the web to a first temperature at or above the melting temperature of the first thermoplastic material, and applying pressure to the web to provide a thermoplastic composite sheet.

In certain examples, the combining step comprises mixing the first thermoplastic material, reinforcing fibers, the expandable graphite materials and the group II metal hydroxide or the group III metal hydroxide until a homogeneous agitated aqueous foam is formed. In other examples, the method comprises heating the web to a second temperature, greater than the first temperature, to loft the expandable graphite materials. In some instances, the method comprises heating the web using convection heating. In other examples, the method comprises applying pressure to the heated thermoplastic composite sheet. In some examples, the method comprises heating the thermoplastic composite sheet using radiant heating. In certain examples, the method comprises disposing an additional flame retardant material on a surface of the thermoplastic composite sheet. In some examples, the method comprises configuring the additional flame retardant material to comprise a divalent metal hydroxide. In certain examples, the method comprises coupling the thermoplastic composite sheet to a skin. In other examples, the method comprises configuring the amount of expandable graphite material and the group II metal hydroxide or the group III metal hydroxide so the sheet meets both a non-oil soaked and an oil-soaked SAE self-extinguishing test as measuring using SAE J369 method (REV. November 2007).

In another aspect, a method comprises combining a first thermoplastic material and reinforcing fibers to form an agitated aqueous foam, disposing the agitated aqueous foam onto a wire support, evacuating the water to form a web, heating the web to a first temperature at or above the melting temperature of the first thermoplastic material, adding an expandable graphite material and the group II metal hydroxide or the group III metal hydroxide to the heated web to provide a composite web, and applying pressure to the composite web to provide a thermoplastic composite sheet.

In certain examples, the method comprises configuring the group II metal hydroxide to comprise calcium hydroxide or magnesium hydroxide. In other examples, the method comprises configuring the group II metal hydroxide to comprise calcium hydroxide or magnesium hydroxide compounded with a polyolefin. In some examples, the method comprises heating the composite web to a second temperature greater than the first temperature to loft the expandable graphite material. In other examples, the method comprises heating the web using convection heating. In some instances, the method comprises heating the thermoplastic composite sheet using radiant heating. In further examples, the method comprises disposing an additional flame retardant material on a surface of the thermoplastic composite sheet. In some embodiments, the method comprises adding a lofting agent to the agitated aqueous foam. In certain examples, the method comprises coupling the thermoplastic composite sheet to a skin. In some examples, the method comprises configuring the amount of expandable graphite material and the group II metal hydroxide or the group III metal hydroxide so the sheet meets both a non-oil soaked and an oil-soaked SAE self-extinguishing test as measuring using SAE J369 method (REV. November 2007).

In an additional aspect, a method comprises combining a first thermoplastic material, reinforcing fibers, expandable graphite materials and a group II metal hydroxide or a group III metal hydroxide to form an agitated aqueous foam, disposing the agitated aqueous foam onto a wire support, evacuating the water to form a web, heating the web to a first temperature at or above the melting temperature of the first thermoplastic material and below a lofting temperature of the expandable graphite materials, and applying pressure to the web to provide a thermoplastic composite sheet.

In certain examples, the method comprises configuring the group II metal hydroxide to comprise calcium hydroxide or magnesium hydroxide. In other examples, the method comprises configuring the group II metal hydroxide to comprise calcium hydroxide or magnesium hydroxide compounded with a polyolefin. In some examples, the method comprises heating the composite web to a second temperature greater than the first temperature to loft the expandable graphite materials. In certain embodiments, the method comprises heating the web using convection heating. In other embodiments, the method comprises heating the thermoplastic composite sheet using radiant heating. In some examples, the method comprises disposing an additional flame retardant material on a surface of the thermoplastic composite sheet. In certain configurations, the method comprises adding a lofting agent to the agitated aqueous foam. In some embodiments, the method comprises coupling the thermoplastic composite sheet to a skin. In other instances, the method comprises configuring the amount of expandable graphite material and the group II metal hydroxide or the group III metal hydroxide so the sheet meets both a non-oil soaked and an oil-soaked SAE self-extinguishing test as measuring using SAE J369 method (REV. November 2007).

In another aspect, a prepreg comprises a web of open cell structures formed by a plurality of reinforcing fibers held together by a first thermoplastic material, wherein the prepreg further comprises expandable graphite materials and a group II metal hydroxide or a group III metal hydroxide in the open cell structures of the web. In certain instances, the group II metal hydroxide comprises calcium hydroxide or magnesium hydroxide. In other instances, the first thermoplastic material is selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

In an additional aspect, a thermoplastic article comprises a porous core layer comprising a web of open cell structures formed by a plurality of reinforcing fibers held together by a first thermoplastic material, wherein the core layer further comprises expandable graphite materials and a group II metal hydroxide or a group III metal hydroxide in the open cell structures of the web, and wherein the amount of expandable graphite material and the group II metal hydroxide or the group III metal hydroxide is selected so the article meets both a non-oil soaked and an oil-soaked SAE self-extinguishing test as measuring using SAE J369 method (REV. November 2007). In some configurations, the group II metal hydroxide comprises calcium hydroxide or magnesium hydroxide. In other instances, the first thermoplastic material is selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof. In some examples, the group II metal hydroxide is magnesium hydroxide that is present at 9 weight percent or more in the article and wherein the expandable graphite materials are present at 5 weight percent or less in the article.

In another aspect, a thermoplastic article comprises a porous core layer comprising a web of open cell structures formed by a plurality of reinforcing fibers held together by a first thermoplastic material, wherein the core layer further comprises expandable graphite materials and a group II metal hydroxide or a group III metal hydroxide in the open cell structures of the web, and a skin disposed on at least one surface of the porous core layer. In some examples, the group II metal hydroxide comprises calcium hydroxide or magnesium hydroxide. In other examples, the first thermoplastic material is selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof. In some instances, the group II metal hydroxide is magnesium hydroxide that is present at 9 weight percent or more in the article and wherein the expandable graphite materials are present at 5 weight percent or less in the article.

In another aspect, a method of producing a thermoplastic composite article comprising a plurality of reinforcing fibers, a thermoplastic material, expandable graphite materials and a group II metal hydroxide or a group III metal hydroxide by heating a mixture of the reinforcing fibers, the thermoplastic material, the expandable graphite materials and the group II metal hydroxide or the group III metal hydroxide to a first temperature above a melting point of the thermoplastic material is described. In some examples, the method comprises selecting the group II metal hydroxide to comprise calcium hydroxide or magnesium hydroxide. In other examples, the method comprises applying pressure to the heated mixture to form the thermoplastic composite article.

Additional features, aspect, examples, configurations and embodiments are described in more detail below.

### BRIEF DESCRIPTION OF THE FIGURES

Certain embodiments are described with reference to the accompanying figures in which:

FIG. 1 is an illustration of a prepreg comprising a compounded flame retardant material or two or more different flame retardant materials, in accordance with certain examples;

FIG. 2A is an illustration of two prepregs comprising different loadings of a compound flame retardant material or two or more different flame retardant materials, in accordance with certain examples;

FIG. 2B is an illustration showing the two prepregs of FIG. 2A after melting together, in accordance with certain configurations;

FIG. 2C is an illustration showing a prepreg comprising a compound flame retardant material (or two or more different flame retardant materials) coupled to a skin, in accordance with certain embodiments;

FIG. 3 is an illustration showing a prepreg or core comprising a compounded flame retardant material (or two or more different flame retardant materials) coupled to a skin, in accordance with certain examples;

FIG. 4 is an illustration showing a prepreg or core comprising a compounded flame retardant material (or two or more different flame retardant materials) coupled to two skins, in accordance with certain examples;

FIG. 5 is another illustration showing a prepreg or core comprising a compounded flame retardant material (or two or more different flame retardant materials) coupled to two skins, in accordance with certain examples;

FIG. 6 is another illustration showing two prepregs or cores comprising a compounded flame retardant material (or two or more different flame retardant materials) coupled to each other through a skin layer, in accordance with certain examples;

FIG. 7 is an illustration showing two prepregs or cores comprising a compounded flame retardant material (or two or more different flame retardant materials) coupled to each other with a skin layer disposed on one of the core layers, in accordance with certain embodiments;

FIG. 8 is an illustration showing two prepregs or cores comprising a compounded flame retardant material (or two or more different flame retardant materials) coupled to each other with a skin layer disposed on each of the core layers, in accordance with certain embodiments;

FIG. 9 is an illustration showing two prepregs or cores comprising a compounded flame retardant material (or two or more different flame retardant materials) coupled to each other through a skin layer and comprising another skin layer disposed on one of the skin layers, in accordance with certain examples;

FIG. 10 is an illustration showing material strips disposed on a core layer, in accordance with certain embodiments;

FIG. 11 is a block diagram of a process to produce a prepreg or core comprising a compound flame retardant material (or two or more different flame retardant materials), in accordance with certain examples; and

FIG. 12 is a block diagram of another process t to produce a prepreg or core comprising a compound flame retardant material (or two or more different flame retardant material)s, in accordance with certain examples.

It will be recognized by the person of ordinary skill in the art, given the benefit of this disclosure, that certain dimensions or features in the figures may have been enlarged, distorted or shown in an otherwise unconventional or non-proportional manner to provide a more user friendly version of the figures. No particular thickness, width or length is intended by the depictions in the figures, and relative sizes of the figure components are not intended to limit the sizes of any of the components in the figures. Where dimensions or values are specified in the description below, the dimensions or values are provided for illustrative purposes only. In addition, no particular material or arrangement is intended to be required by virtue of shading of certain portions of the figures, and even though different components in the figures may include shading for purposes of distinction, the different components can include the same or similar materials, if desired. In some instances, core layers that comprise compounded flame retardant material (or two or more different flame retardant materials) are shown as including stubble or dots for illustration purposes. The arrangement of the stubbles and dots is not intended to imply any particular distribution unless otherwise specified in the context of describing that particular figure.

### DETAILED DESCRIPTION

Certain embodiments are described below with reference to singular and plural terms in order to provide a more user friendly description of the technology disclosed herein. These terms are used for convenience purposes only and are not intended to limit the prepregs, cores, articles, composites and other subject matter as including or excluding certain features unless otherwise noted as being present in, or excluded from, a particular embodiment described herein.

In certain instances, thermoplastic composite articles are often molded or processed into various shapes to provide a final formed part or article. The exact final article formed may depend on the particular use application. For example, in some instances, the prepregs and cores described herein may be provided in sheet form which can then be molded, trimmed or shaped to a desired geometry or structure. In certain instances, the sheets may be processed to provide office furniture or indoor building products including, but not limited to, cubicles, wall coverings, e.g., wall covering which can attached to wall studs or cover existing drywall or other materials attached to wall studs, seatbacks, seat frames, roofing panels, ceiling panels, flooring or other articles which may be used in office or building applications. In other instances, the composite articles can be used in exterior automotive applications including underbody shields, skid plates and the like. As noted in more detail below, the composite articles can be produced in many different ways, though in most instances the composite articles are non-extruded composite articles to provide a porous prepreg or core layer.

In some configurations described herein, the presence of compounded flame retardant material in a thermoplastic prepreg or a thermoplastic core permits the prepreg or core to provide flame retardancy to at least some degree. For example, the prepreg or core may meet the Class A standard of ASTM E84 test dated 2009 and entitled “Standard Test Method for Surface Burning Characteristics of Building Materials”). For example, the particular compounded flame retardant material selected for use in the core layer may provide an article that meets the ASTM E84 class A or class B requirements in an as-produced article, e.g., without any molding, or in a molded article if desired. Class A articles differ from class B articles in that class A articles have a flame spread index of about 0-25 whereas class B articles have a flame spread index of about 26-75. In some instances, enough of the compounded flame retardant material is present in the final prepreg or core so the prepreg or core meets the class A standard under the ASTM E84 test dated 2009.

In other configurations described herein, the composite article may comprise EG materials in combination with one or more other flame retardant materials such that the composite article meets the SAE J369 method (REV. November 2007). This test method is referred to in certain instances in the description and claims as a SAE flammability test or a SAE self-extinguishing test. In some examples, less than 10 weight percent EG materials, less than 9 weight percent EG materials, less than 8 weight percent EG materials, less than 7 weight percent EG materials, less than 6 weight percent EG materials or even less than 5 weight percent EG materials can be present in the prepreg or core layer and enough of the other flame retardant material is present in the prepreg or core layer so the composite article meets or passes the non-oil soaked and oil-soaked SAE flammability tests.

In some embodiments, the exact material used as the compounded flame retardant material may vary depending on the desired overall properties of the prepreg or core and/or the methods used to produce the prepreg or core. The compounded flame retardant material typically comprises a flame retardant agent or material that has been compounded with another material. For example, the compounded flame retardant material may comprise a flame retardant agent that has been compounded with one or more thermoplastic or thermoset materials. Where the prepreg or core comprises a thermoplastic material in combination with reinforcing fibers, one material present in the compounded flame retardant material may also be a thermoplastic material. The virgin thermoplastic material in the prepreg or core may be the same or may be different from the thermoplastic material present in the compounded flame retardant. In some instances where a thermoplastic material is present in the compounded flame retardant material, the thermoplastic material of the compounded flame retardant material may comprise one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic materials for use in the compounded flame retardant material include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. compounded flame retardant materials comprising a thermoplastic material compounded with a flame retardant material are referred to in certain instances herein as compounded flame retardant thermoplastic material.

In certain embodiments, the flame retardant agent used in the compounded flame retardant material may comprise many different materials including organic and inorganic flame retardant materials. In certain configurations, the flame retardant agent of the compounded flame retardant material may comprise an inorganic material or inorganic salt. For example, restrictions on hazardous substances (RoHS) may make it desirable to select the flame retardant material as an inorganic salt that is substantially free (or free) of any halides. In some embodiments, the flame retardant material may comprise a group II metal or a group III metal in combination with one or more anions. For example, the flame retardant material of the compounded flame retardant material may comprise beryllium, calcium, magnesium or other Group II metal salts. In some embodiments, the Group II metal of the compounded flame retardant material may be present as a hydroxide material. For example, the flame retardant material may be present as beryllium hydroxide, calcium hydroxide, magnesium hydroxide or other group II metal hydroxides. In other instances, the flame retardant material of the compounded flame retardant material may comprise aluminum, gallium, indium or other Group III metal salts. In some embodiments, the Group III metal salt of the compounded flame retardant material may be present as a hydroxide material. For example, the flame retardant material may be present as aluminum hydroxide or gallium hydroxide or other group III metal hydroxides.

In other configurations, the inorganic material present as a compounded flame retardant material may comprise one or more transition metal salts which can function as flame retardant materials. For example, transition metals which can form divalent cations in solution may be combined with one or more anions and used as flame retardant agents. In some instances, the transition metal salt may be present in non-halide form, e.g., may not be present as a fluoride, chloride, bromide or iodide salt, to avoid outgassing of toxic gases should the prepreg or core undergo burning. In certain configurations, the transition metal salt may be present, for example, as a hydroxide.

The exact amount of the compounded flame retardant material used in the prepregs and cores may vary depending on which other materials are present, but the compounded flame retardant material typically is present at a weight percentage less than a major amount of the prepreg or core, e.g., the compounded flame retardant material is typically present at 50 weight percent or less based on the weight of the prepreg or core. In certain instances, the compounded flame retardant material is present above a minor amount to provide flame retardancy to the prepreg or core. For example, the compounded flame retardant material may be present at 30 weight percent or more, 35 weight percent or more, 40 weight percent or more or even 45 weight percent or more based on the weight of the prepreg or core. Illustrative compounded flame retardant materials are commercially available from Washington Penn Plastic Co. (Washington, Pa.) or may be produced by mixing of a suitable flame retardant material with a suitable thermoplastic material or other material. For example, the flame retardant material, e.g., group II hydroxide, can be mixed with another material, e.g., thermoplastic material, using an extrusion process. In some instances, the thermoplastic material is added to an extruder and melted. The melted polymer can be pushed or propelled into a barrel where the flame retardant material is then added. The resulting mixture is propelled forward, which acts to mix the flame retardant material into the melted thermoplastic material. The resulting mixture may then be cooled to form solid materials such as particles or pellets. The particular ratio of the flame retardant material to thermoplastic material can vary. For example, the flame retardant material:other material ratio may vary from 1:1, 2:1 3:1, 4:1: 5:1, 1:5, 1:4, 1:3 or 1:2. In instances where the compounded flame retardant material comprises an inorganic flame retardant salt in combination with a thermoplastic material, the inorganic salt typically is present in the compounded flame retardant material in a higher amount. For example, the ratio of inorganic salt:thermoplastic material may be about 2:1, 3:1, 3:2, 5:2, 7:2, 4:3, 5:3, 7:3, 8:3, 5:4, 7:4, 9:4, 11:4, 6:5, 7:5, 8:5, 9:5, 11:5, 13:5 or other ratios. If desired, however, the thermoplastic material could be present in an equal amount by weight in the compounded flame retardant material or may even be present in the compounded flame retardant material in an amount by weight that is higher than the flame retardant material.

Depending on the particular process used to produce the prepregs or core, the compounded flame retardant material can be ground, filtered, sized or otherwise processed prior to adding it to the other materials of the prepreg or core. In some instances where thermoplastic particles are used in the prepreg or core, the average particle size of the compounded flame retardant material may be about the same as the average particle size of the thermoplastic material. In other configurations, the average particle size of the compounded flame retardant material may be smaller or larger than the average particle size of the thermoplastic material used in the prepreg or core.

In some instances, two or more different flame retardants can be used in combination with thermoplastic materials and reinforcing fibers. If desired, one of the flame retardants can be a compounded flame retardant as described herein. For example, in some instances, one of the flame retardants may comprise expandable graphite (EG) materials and the other flame retardant may comprise a group II or group III metal salt. For example, the EG material can be used in combination with beryllium, calcium, magnesium or other Group II metal salts or in combination with aluminum, gallium, indium or other Group III metal salts. In other examples, the EG material can be used in combination with a group II or group III metal hydroxide. For example, the EG material can be used in combination with beryllium hydroxide, calcium hydroxide, magnesium hydroxide or other group II metal hydroxides or in combination with aluminum hydroxide or gallium hydroxide or other group III metal hydroxides. The non-EG flame retardant material can be present in a compounded form or a non-compounded form as desired. For example, the EG material can be used in combination with MDH compounded with PP or aluminum hydroxide (ATH) compounded with PP. In other configurations, the EG material can be used with native MDH or native ATH. Without wishing to be bound by any particular theory, by using a non-EG flame retardant in combination with an EG flame retardant, the overall amount of EG material can be reduced while still providing desired flame retardancy. The exact type of expandable graphite materials used in the prepreg can depend on numerous factors including, for example, the desired level of flame retardancy. Illustrative commercially available expandable graphite materials are available from Nyacol Nano Technologies, Inc. (Ashland, Mass.) and include, for example, grades 35, 200, 249, 250, 251, KP251 and 351 expandable graphite materials. Additional expandable graphite material can be purchased commercially from Graftech International (Lakewood, Ohio). Expandable graphite material can generally be produced by acidifying a graphite ore. Acidification results in an intercalation process, e.g., where sulfuric acid acts as an intercalator. The solution can then be neutralized to provide a series of layers of sheets of hexagonal carbon-carbon bonded materials. The layers are generally flat and interact with additional hexagonal carbon-carbon layers to provide a layered sheet structure. The layered sheet structure can be held together through covalent bonding or electrostatic interactions (or both) between sheets. If desired, the expandable graphite material can be oxidized using a suitable oxidant to form a graphene oxide. As noted herein, the expandable graphite material can be present in many forms including flake form, particle form or other forms. In some instances, the expandable graphite material is present in particle form and may comprise an average particle size of at least 300 microns, for example. In some configurations, the form of the EG material is selected to be the same as the form of the non-EG flame retardant, e.g., both can be used in flake form.

In certain configurations, the articles described herein can comprise a prepreg or core layer. While not wishing to be bound by any particular theory, a prepreg is generally not a fully formed or processed version of a core. For example, a partially formed layer comprising a thermoplastic material, a plurality of fibers and compounded flame retardant material (or EG material in combination with a different flame retardant material) is generally referred to as a prepreg, whereas a fully formed layer comprising thermoplastic material, a plurality of fibers and compounded flame retardant material (or EG material in combination with a different flame retardant material) is generally referred to as a core or core layer. As noted herein, even though the core may be considered formed or cured, the core can still be coupled to one or more skin layers to alter the overall properties of a composite article comprising the core layer. The description below makes reference to both a prepreg and a core and the materials (and their amounts and properties) used in connection with a prepreg can also be used in a core if desired.

In some instances, the prepregs, cores and articles described herein are porous or permeable materials that comprise open cell structures, e.g., voids. The presence of such open cell structures that are formed from thermoplastic material renders it more difficult for the prepregs, cores and articles to meet flame retardancy standards. By including a compounded flame retardant material in combination with a thermoplastic material and fibers, the prepregs, cores and article can be flame retardant and meet the Class A requirements of the ASTM E84 test. For example, an article comprising a porous core layer comprising a plurality of reinforcing fibers, a thermoplastic material, and an effective amount of a compounded flame retardant material can have a flame spread index of 25 or less as tested by ASTM E84. In some examples, by using EG material in combination with a different flame retardant (which may or may not be compounded with another material), the prepreg or core can meet the SAE flammability test for non-oil soaked an oil soaked samples. If desired, the flame retardant materials or compounded flame retardant material can be homogeneously dispersed in void space of the porous core layer or may be present in a differential distribution with more flame retardant material being present in one or more areas or closer to one or more surfaces of the core layer. As noted below, skins or other materials may also be disposed on the porous core layer if desired and can be selected to further enhance flame retardancy. In some instances, the compounded flame retardant material and the amount of compounded flame retardant material in the core layer can be selected such that the final produced article, e.g., one with a skin, meets the ASTM E84 class A requirements. In other instances, the flame retardant materials and the amount of the flame retardant materials in the core layer can be selected such that the final produced article, e.g., one with a skin, meets the SAE flammability test. As noted herein, articles that meet one or more of the E84, class A requirements or the SAE flammability test can be used in many different applications including, for example, as recreational vehicle panels, office cubicle walls, building panels that can replace drywall or similar materials, roofing panels, structural panels, flooring, in automotive applications, e.g., interior panels, underbody shields, engine covers, etc., in aerospace applications as interior aircraft panels, aircraft floor panels or as other building, automotive or aerospace applications.

In certain configurations, a porous prepreg comprising one or more thermoplastic materials and a plurality of fibers that together provide an open cell structure, e.g., void space, can be produced. In some configurations, flame retardant materials, e.g., EG materials, Group II metal salts, Group III metal salts, compounded flame retardant materials, etc. can be loaded into the void space in a manner where the flame retardant materials reside (at least in part) within the void space formed by crossing over of the fibers, which can be held in place by the thermoplastic material. In some instances, the thermoplastic materials and/or the fibers can be selected so that they are generally inert or non-reactive with the flame retardant materials. In some examples, the flame retardant materials may not covalently bond to the thermoplastic material and/or the fibers, but there may be an association between any charged flame retardant material with the thermoplastic material of the porous prepreg. For example, weak interactions such as van der Waals' interactions or electrostatic interactions can take place between the flame retardant material and the other components of the prepreg or core.

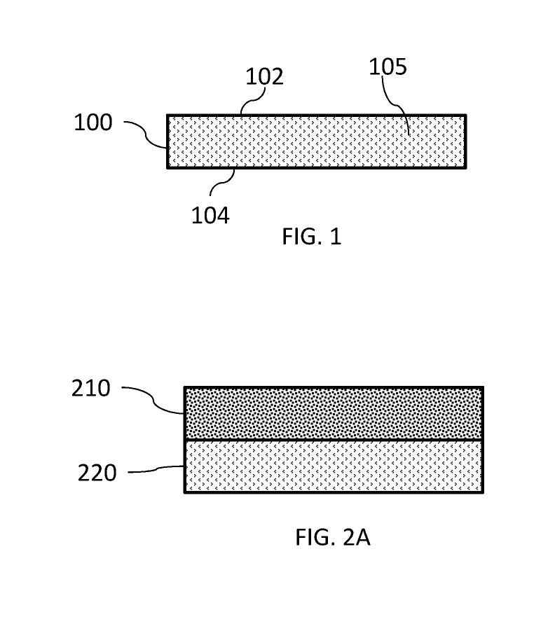

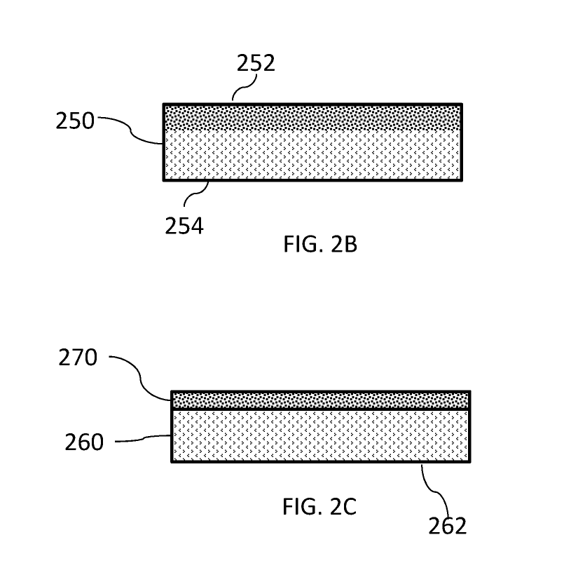

In certain examples and referring to FIG. 1, a prepreg 100 is shown that comprises a thermoplastic material and a plurality of fibers. The prepreg 100 also comprises one or more flame retardant materials (shown for illustration purposes as dots 105) dispersed through the prepreg 100. In some examples, the flame retardant material 105 is a compounded flame retardant material, an EG material in combination with a Group II salt or a Group III salt, an EG material in combination with magnesium hydroxide, an EG material in combination with aluminum hydroxide, etc. In some instances, the flame retardant material dispersion can be substantially homogeneous or substantially uniform from a first surface 102 to a second surface 104 of the prepreg 100. As described in more detail herein, to achieve such substantially homogeneous or substantially uniform distribution of flame retardant material(s) in the prepreg 100, the components of the prepreg 100 can be mixed together to form a dispersion. Mixing can be performed until the dispersion comprises a substantially homogeneous or substantially uniform mixture of the flame retardant material(s), the thermoplastic materials and the fibers in the dispersion. The prepreg 100 may then be formed as described herein, e.g., by disposing the dispersion on a wire screen using a suitable laying process. In other configurations, it may be desirable to provide a gradient distribution of flame retardant material(s) from the surface 102 to the surface 104 such that more flame retardant material(s) is present towards one of the surfaces 102, 104 than the other surface. In some embodiments, a substantially uniform distribution of flame retardant material is present in a prepreg 100 and then additional flame retardant material (which may be the same or different) is added to one side of the prepreg 100 to provide a gradient distribution. Such additional flame retardant material can be added directly to the prepreg 100, e.g., by spraying powdered flame retardant material or coating a solution comprising the flame retardant material or can be added by coupling a skin, additional prepreg or other component comprising flame retardant material to the prepreg 100. For example and referring to FIG. 2A, a first prepreg 210 and a second prepreg 220 disposed on the first prepreg 210 is shown. Each of the first prepreg 210 and the second prepreg 220 comprises a substantially uniform distribution of flame retardant material, but the amount by weight of flame retardant material in the prepregs 210, 220 is different. If desired, however, only one of the prepregs 210, 220 may comprise flame retardant material and the other prepreg may not comprise any flame retardant material or may comprise a different flame retardant material. The thermoplastic materials of the prepregs 210, 220 can be melted and/or compressed to provide a single prepreg 250 (FIG. 2B). The result of melting of the prepregs 210, 220 together is a gradient distribution of the flame retardant material in the prepreg 250 with increased amounts of flame retardant material adjacent to a surface 252 as compared to the amount present adjacent to a surface 254. The exact overall thickness of the prepreg 250 may vary depending on the conditions used and no particular thickness is intended to be implied in FIG. 2B. While not shown, a third prepreg similar to the prepreg 210 could be coupled to an opposite surface of the prepreg 220 to provide a 3-layer prepreg, which can be melted to provide flame retardant material at higher amounts adjacent to each of the surfaces of the composite prepreg. While not wishing to be bound by any particular theory, by varying the amount and/or type of flame retardant material at different depths of the prepreg, enhanced flame retardancy may be provided at a surface of the prepreg, within the interior of the prepreg or both.

In other configurations, a distribution of flame retardant material in a prepreg can be provided by coupling a skin or other material comprising flame retardant material to the prepreg. Referring to FIG. 2C, a skin 270 comprising flame retardant material is shown as being disposed on a prepreg 260 comprising a thermoplastic material, reinforcing fibers and flame retardant material. While not required, the skin 270 is typically present at a much lower thickness than the thickness of the prepreg 260. In addition, a discernible interface is typically present between the skin 270 and the interface 260, whereas coupling of two prepregs to each other, as described in connection with FIG. 2B, generally does not result in any discernible interface in the finally coupled prepreg 250. In other instances, the skin 270 can be melted into the prepreg 260 to couple the skin 270 and the prepreg 260 to leave a coupled skin/prepreg composite material without any substantial interface. If desired and as described in more detail below, an additional skin, which may or may not comprise a flame retardant material, can also be coupled to the prepreg on an opposite side from the skin 270. While the exact composition of the skin 270 may vary, in some instances, the skin 270 may itself impart some flame retardancy to the overall prepreg. The skin 270 may be an open structure skin, e.g., include open cell structures, or may be a closed structure skin. For example, the skin 270 may comprise an open structure to permit a flame to enter into the prepreg 260 where it can contact the flame retardant material.

In certain configurations, the thermoplastic material of the prepreg may be present in fiber form, particle form, resin form or other suitable forms. In some instances, the thermoplastic material used in the prepreg can be present in particle form and have an average particle size that is substantially the same as the average particle size of the flame retardant material. While not wishing to be bound by any particular scientific theory, by matching the particles sizes of the thermoplastic material and the flame retardant material, enhanced processing of the prepregs including, for example, increased loading of the flame retardant material in the prepreg can be achieved. In some instances, the average particle size of the flame retardant material and the average particle size of the thermoplastic material can vary by about 5% to about 10% and enhanced processing can still be achieved. In certain configurations, the average particle size of each of the thermoplastic material and the flame retardant material in the prepreg can differ by about 50 microns to about 100 microns. In some configurations, the average particle size of the flame retardant material is at least 50% of the average particle size of the thermoplastic material particles to provide for enhanced processing. In other instances, flame retardant material with an average particle size about the same as the average particle size of the thermoplastic material can be present along with flame retardant material of an average particle size that is different than the average particle size of the thermoplastic material. Even though the average particle size of the flame retardant material may differ, the chemical composition of the flame retardant material can be the same or can be different. In yet other configurations, two or more thermoplastic materials with different average particle sizes can be present. If desired, two flame retardant materials with average particle sizes that are substantially the same as the average particle sizes of the thermoplastic materials can be present. The two flame retardant materials may be chemically the same or may be chemically distinct. Similarly, the thermoplastic materials can be chemically the same (but have a different average particle size) or can be chemically distinct. In certain instances, the virgin or native thermoplastic material used to produce the prepreg may be the same thermoplastic material that is present in a compounded flame retardant material. In other instances, the compounded flame retardant material may comprise two or more thermoplastic materials where one of the thermoplastic materials is the same as the virgin thermoplastic material used to produce the prepreg.

In certain embodiments, the prepreg 100 generally comprises a substantial amount of open cell structure such that void space is present in the prepreg. For example, the prepreg may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the prepreg comprises a porosity or void content of greater than 0%, e.g., is not fully consolidated, up to about 95%. Unless otherwise stated, the reference to the prepreg comprising a certain void content or porosity is based on the total volume of the prepreg and not necessarily the total volume of the prepreg plus any other materials or layers coupled to the prepreg.

In certain embodiments, the high porosity present in the prepreg permits trapping of the flame retardant material within the pores of the prepreg and/or capture of the flame retardant material as a coating on the thermoplastic material. For example, flame retardant material can reside in the void space in a non-covalently bonded manner. The presence of the flame retardant material in the void space can provide for enhance flame retardancy. The flame retardant material can also be coated onto a surface of the prepreg to provide enhanced flame retardancy.

In certain embodiments, the thermoplastic material of the prepregs described herein may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. Where the compounded flame retardant material also comprises a thermoplastic material compounded with a flame retardant material, the thermoplastic material of the compounded flame retardant material may be the same material as that selected for use as the virgin thermoplastic material of the prepreg. The virgin thermoplastic material used to form the prepreg can be used in powder form, resin form, rosin form, fiber form or other suitable forms. Illustrative thermoplastic materials in various forms are described herein and are also described, for example in U.S. Publication Nos. 20130244528 and US20120065283. The exact amount of thermoplastic material present in the prepreg can vary and illustrative amounts range from about 20% by weight to about 80% by weight.

In certain examples, the fibers of the prepregs described herein can comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, natural fibers such as hemp, sisal, jute, flax, coir, kenaf and cellulosic fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, the compounded flame retardant material or both. Alternatively, the flame retardant material can be reacted with the thermoplastic material of the prepreg to provide a derivatized thermoplastic material that is then mixed with the fibers. The fiber content in the prepreg may be from about 20% to about 90% by weight of the prepreg, more particularly from about 30% to about 70%, by weight of the prepreg. Typically, the fiber content of a composite article comprising the prepreg varies between about 20% to about 90% by weight, more particularly about 30% by weight to about 80% by weight, e.g., about 40% to about 70% by weight of the composite. The particular size and/or orientation of the fibers used may depend, at least in part, on the polymer material used and/or the desired properties of the resulting prepreg. Suitable additional types of fibers, fiber sizes and amounts will be readily selected by the person of ordinary skill in the art, given the benefit of this disclosure. In one non-limiting illustration, fibers dispersed within a thermoplastic material to provide a prepreg generally have a diameter of greater than about 5 microns, more particularly from about 5 microns to about 22 microns, and a length of from about 5 mm to about 200 mm; more particularly, the fiber diameter may be from about microns to about 22 microns and the fiber length may be from about 5 mm to about 75 mm. In some configurations, the flame retardant material may be present in fiber form. For example, the prepreg, core or composite may comprise a thermoplastic material, reinforcing fibers and fibers comprising a compounded flame retardant material or fibers comprising an EG material. The flame retardant fibers may comprise any one or more of the flame retardant materials described herein, e.g., polypropylene fibers compounded with a hydroxide material which is then extruded and cut into fibers using a suitable die or other devices, or EG materials mixed with polypropylene fibers compounded with a hydroxide material which is then extruded and cut into fibers using a suitable die or other devices.

In some configurations, the prepreg may be a substantially halogen free or halogen free prepreg to meet the restrictions on hazardous substances requirements for certain applications. In other instances, the prepreg may comprise a halogenated flame retardant agent (which can be present in the flame retardant material or may be added in addition to the flame retardant material) such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the prepregs and cores may comprise one or more halogens to impart some flame retardancy without the addition of another flame retardant agent. For example, the thermoplastic material of the compounded flame retardant material may be halogenated in addition to being compounded with a flame retardant material, or the virgin thermoplastic material may be halogenated. Where halogenated flame retardants are present, the flame retardant is desirably present in a flame retardant amount, which can vary depending on the other components which are present. For example, the halogenated flame retardant where present in addition to the compounded flame retardant material may be present in about 0.1 weight percent to about 15 weight percent (based on the weight of the prepreg), more particularly about 1 weight percent to about 13 weight percent, e.g., about 5 weight percent to about 13 weight percent. If desired, two different halogenated flame retardants may be added to the prepregs. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the prepregs may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the prepreg), more particularly about 1 weight percent to about 13 weight percent, e.g., about 5 weight percent to about 13 weight percent based on the weight of the prepreg. If desired, two different substantially halogen free flame retardants may be added to the prepregs. In certain instances, the prepregs described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants (exclusive of any compounded flame retardant material) present may be about 0.1 weight percent to about 20 weight percent (based on the weight of the prepreg), more particularly about 1 weight percent to about 15 weight percent, e.g., about 2 weight percent to about 14 weight percent based on the weight of the prepreg. The flame retardant agents used in the prepregs described herein can be added to the mixture comprising the thermoplastic material and fibers (prior to disposal of the mixture on a wire screen or other processing component) or can be added after the prepreg is formed.

In certain configurations, the articles described herein may comprise a porous core. In certain examples, the porous core comprises one or more thermoplastic materials and a plurality of fibers that can be held in place by the formed thermoplastic material in a web or network structure to provide a plurality of open cells, void space or a web in the core. In some instances, a flame retardant material can be present in the void space of the core, e.g., in the open cells of a web formed from the reinforcing fibers held together by the thermoplastic material, or may be present on the fibers of the core or both. In certain configurations, a core similar to the prepreg of FIG. 1 can be produced. The core comprises flame retardant material dispersed generally throughout the core. In some instances, the flame retardant material dispersion can be substantially homogeneous or substantially uniform from a first surface to a second surface of the core. As described in more detail herein, to achieve such substantially homogeneous or substantially uniform distribution of flame retardant material in the core, the components of the core can be mixed together to form a dispersion prior to forming the core. Mixing can be performed until the dispersion comprises a substantially homogeneous or substantially uniform mixture of the flame retardant material(s), the thermoplastic material and the fibers in the dispersion. The core may then be formed as described herein, e.g., by disposing the dispersion on a wire screen using a suitable laying process followed by compressing and/or curing of the thermoplastic material of the core. In other configurations, it may be desirable to provide a gradient distribution of flame retardant material(s) from one surface of the core to the other surface of the core. In some configurations, a substantially uniform distribution of flame retardant material is present in a core and then additional flame retardant material is added to one side of the core to provide a gradient distribution. Such additional flame retardant material can be added directly to the core, e.g., by spraying or coating or by using a solution comprising the flame retardant material, or can be added by coupling a skin, additional prepreg or core or other component comprising flame retardant material to the core. For example, a first core and a second core disposed on the first core can provide a composite article. Each of the cores may comprise a substantially uniform distribution of flame retardant material, but the amount and/or type of flame retardant material in the two cores can be different, e.g., the loading rates can be different or the flame retardant materials themselves may be different. If desired, however, only one of the cores may comprise flame retardant material and the other core may not comprise materials other than the thermoplastic material and reinforcing fibers. The thermoplastic materials of the cores can be melted to provide a single combined core including materials from the two cores. The result of melting of the cores is a composite core with a gradient distribution of flame retardant material. In other configurations, a distribution of flame retardant material in a core can be provided by coupling a skin or other material comprising flame retardant material to the core. In other instances, the skin can be melted into the core to couple the skin and the core to leave a coupled skin/core composite material without any substantial interface. If desired and as described in more detail below, an additional skin, which may or may not comprise flame retardant material can also be coupled to the core on an opposite side from the first skin.

In certain configurations, the thermoplastic material of the core may be used in the core in a fiber form, particle form, resin form or other suitable forms. In some examples, the thermoplastic material used in the core can be present in particle form and have an average particle size that is substantially the same as the average particle size of the flame retardant material. By matching the particles sizes of the thermoplastic material and the flame retardant material, enhanced processing of the cores including, for example, increased retention of the flame retardant material in the core, which can act to increase the level of flame retardancy of the core. In some instances, the average particle size of the flame retardant material and the average particle size of the thermoplastic material can vary by about 5% to about 10% and enhanced processing can still be achieved. In certain configurations, the average particle size of each of the thermoplastic material and the flame retardant material in the core can range from about 50 microns to about 900 microns. In other instances, flame retardant material with an average particle size about the same as the average particle size of the thermoplastic material can be present along with flame retardant material of an average particle size that is different than the average particle size of the thermoplastic material. Even though the average particle size of the flame retardant material may differ, the chemical composition of the flame retardant material can be the same or can be different. In yet other configurations, two or more thermoplastic materials with different average particle sizes can be present. If desired, two flame retardant material with average particle sizes that are substantially the same as the average particle sizes of the two thermoplastic materials can be present in the core. The two flame retardant materials may be chemically the same or may be chemically distinct. Similarly, the thermoplastic materials can be chemically the same (but have a different average particle size) or can be chemically distinct.

In certain embodiments, the core generally comprises a substantial amount of open cell structure such that void space is present in the core. For example, the core layer may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 5-30%, 5-40%, 5-50%, 5-60%, 5-70%, 5-80%, 5-90%, 5-95%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the core comprises a porosity or void content of greater than 0%, e.g., is not fully consolidated, up to about 95%. Unless otherwise stated, the reference to the core comprising a certain void content or porosity is based on the total volume of the core and not necessarily the total volume of the core plus any other materials or layers coupled to the core. Compared to a prepreg, the porosity of the core can be the same or can be different. For example, in many instances, a prepreg is formed into a core by passing a prepreg through a set of rollers or by pressing one surfaces of the prepreg. In such instances, the porosity of the core may be different than the porosity of the prepreg, e.g., can be lower. In some instances, the porosity of the core is intentionally selected to be less than a comparable prepreg to provide for increased lofting capacity of the core into a final formed article or product.

In certain embodiments, the high porosity present in the core permits trapping of flame retardant within the pores of the core. For example, flame retardant material from compounded flame retardant material can reside in the void space in a non-covalently bonded manner. In other instances, the flame retardant material may be coated onto the reinforcing fibers present in the core.

In certain embodiments, the thermoplastic material of the cores described herein may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. The thermoplastic material used to form the core can be used in powder form, resin form, rosin form, fiber form or other suitable forms. Illustrative thermoplastic materials in various forms are described herein and are also described, for example in U.S. Publication Nos. 20130244528 and US20120065283. The exact amount of thermoplastic material present in the core can vary and illustrative amounts range from about 20% by weight to about 80% by weight. As noted in connection with the prepregs, the thermoplastic material used to produce the core may comprise a common or the same thermoplastic material as is present in the compounded flame retardant material.

In certain examples, the fibers of the cores described herein can comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, natural fibers such as hemp, sisal, jute, flax, coir, kenaf and cellulosic fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, the flame retardant material, the compounded flame retardant material or both. The fiber content in the core may be from about 20% to about 90% by weight of the core, more particularly from about 30% to about 70%, by weight of the core. The particular size and/or orientation of the fibers used may depend, at least in part, on the polymer material used and/or the desired properties of the resulting core. Suitable additional types of fibers, fiber sizes and amounts will be readily selected by the person of ordinary skill in the art, given the benefit of this disclosure. In one non-limiting illustration, fibers dispersed within a thermoplastic material to provide a core generally have a diameter of greater than about 5 microns, more particularly from about 5 microns to about 22 microns, and a length of from about 5 mm to about 200 mm; more particularly, the fiber diameter may be from about microns to about 22 microns and the fiber length may be from about 5 mm to about 75 mm.

In some instances, the core may be a substantially halogen free or halogen free core to meet the restrictions on hazardous substances requirements for certain applications. In other instances, the core may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. If desired, the halogen groups can be present by including a compounded, halogenated flame retardant material or may be present on the thermoplastic material or may be added separate from the other materials used to produce the core. In some instances, the virgin thermoplastic material used in the cores may comprise one or more halogens to impart some flame retardancy without the addition of another flame retardant agent. Where halogenated flame retardants are present, the flame retardant is desirably present in a flame retardant amount, which can vary depending on the other components which are present. The presence of EG materials in combination with another flame retardant material or the presence of a compounded flame retardant material may permit the use of low amounts of halogenated flame retardants which can act synergistically with the flame retardant material from the other flame retardant materials. For example, the halogenated flame retardant may be present in about 0.1 weight percent to about 15 weight percent (based on the weight of the core), more particularly about 1 weight percent to about 13 weight percent, e.g., about 5 weight percent to about 13 weight percent. If desired, two different halogenated flame retardants may be added to the core. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the cores may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the core), more particularly about 1 weight percent to about 13 weight percent, e.g., about 5 weight percent to about 13 weight percent based on the weight of the cores. If desired, two different substantially halogen free flame retardants may be added to the cores. In certain instances, the cores described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present (exclusive of the weight present from the compounded flame retardant material) may be about 0.1 weight percent to about 20 weight percent (based on the weight of the core), more particularly about 1 weight percent to about 15 weight percent, e.g., about 2 weight percent to about 14 weight percent based on the weight of the core. The flame retardant agents used in the cores described herein can be added to the mixture comprising the thermoplastic material and fibers (prior to disposal of the mixture on a wire screen or other processing component) or can be added after the core is cured, e.g., by soaking the core in the flame retardant agent or spraying flame retardant agent on the core.

In certain embodiments, the reinforcing fibers and virgin thermoplastic material of the prepregs and core may be combined with a compounded thermoplastic flame retardant material to provide a prepreg or core that meets the Class A standard under the ASTM E84 test. The thermoplastic material from the compounded thermoplastic flame retardant material may comprise the same material as the virgin thermoplastic material or a different thermoplastic material. The compounded thermoplastic flame retardant material may comprise one or more divalent or trivalent metal salts as a flame retardant material. For example, the compounded thermoplastic flame retardant material may comprise a Group II metal hydroxide material that has been compounded with a thermoplastic material such as a polyolefin or other suitable thermoplastic materials described herein. In other instances, the compounded thermoplastic flame retardant material may comprise a Group III metal hydroxide material that has been compounded with a thermoplastic material such as a polyolefin or other suitable thermoplastic materials described herein.

In certain instances, one or more lofting agents may be added to the prepregs or cores to permit lofting. For example, lofting agents such as microspheres or expandable graphite materials may be added to the prepregs or core to permit adjustment of the overall thickness of the prepreg or core. Without wishing to be bound by any particular theory, as the prepreg or core is heated, the lofting agent may function to increase the overall thickness of the prepreg or core. If desired, the prepregs or cores with the lofting agents may be compressed to permit an end user to apply heat to expand the prepreg or core thickness to a desired amount. Depending on the end use of the prepreg or core, it may be desirable to have different overall thickness for different types of articles. The amount of EG materials can be selected to provide a desired lofting capacity and/or a desired flame retardancy effect. For example, the level of EG materials can be about 1 weight percent to about 5 weight percent to provide a desired lofting capacity and can be used in combination with another flame retardant material so together the EG material and flame retardant material meet the non-oil soaked SAE and oil-soaked SAE self-extinguishing test.

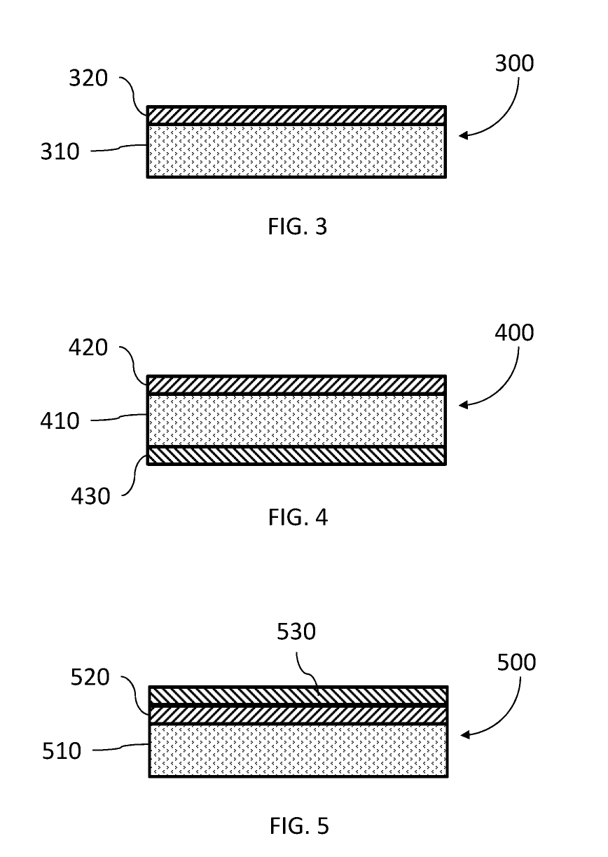

In certain embodiments, the prepregs or cores described herein may comprise one or more skins disposed on a surface of the prepreg or core to provide an article. Referring to FIG. 3, an article 300 comprises a prepreg or core 310 that comprises a thermoplastic material, a plurality of fibers and compounded flame retardant material or two or more different flame retardant materials, e.g., EG materials in combination with a Group II or Group III metal hydroxide. The article 300 comprises a first skin 320 disposed on the prepreg or core 310. The skin 320 may comprise an open cell structure or a closed cell structure. In certain configurations, the skin 320 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the prepreg or core 310. In other instances, the skin 320 may comprise a limiting oxygen index greater than about 22, as measured per ISO 4589 dated 1996. Where a thermoplastic film is present as (or as part of) the skin 320, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin 320, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin 320, the coating may comprise at least one of unsaturated polyurethanes, vinyl esters, phenolics and epoxies. Where an inorganic coating is present as (or as part of) the skin 320, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin 320, the non-woven fabric may comprise a thermoplastic material, a thermal setting binder, inorganic fibers, metal fibers, metallized inorganic fibers and metallized synthetic fibers. The prepreg or core 310 may comprise any of the materials described herein in connection with prepregs and cores, e.g., a thermoplastic material, reinforcing fibers and compounded flame retardant material or two or more different flame retardant materials, e.g., EG materials in combination with a Group II or Group III metal hydroxide. If desired, the skin 320 may comprise a compounded flame retardant material as well.

In certain configurations, the prepregs and cores described herein can be used to provide an article comprising a skin on each side of the prepreg or core. Referring to FIG. 4, an article 400 is shown comprising a prepreg or core 410, a first skin 420 disposed on a first surface of the prepreg or core 410 and a second skin 430 disposed on the prepreg or core 410. The prepreg or core 410 may comprise any of the materials described herein in connection with prepregs and cores, e.g., a thermoplastic material, reinforcing fibers and a compounded flame retardant material or two or more different flame retardant materials, e.g., EG materials in combination with a Group II or Group III metal hydroxide. Each of the first skin 420 and the second skin 430 can be independently selected from a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the prepreg or core 410. In other instances, the skin 420 or the skin 430 (or both) may comprise a limiting oxygen index greater than about 22, as measured per ISO 4589 dated 1996. Where a thermoplastic film is present as (or as part of) the skin 420 or the skin 430 (or both), the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin 420 or the skin 430 (or both), the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin 420 or the skin 430 (or both), the coating may comprise at least one of unsaturated polyurethanes, vinyl esters, phenolics and epoxies. Where an inorganic coating is present as (or as part of) the skin 420 or the skin 430 (or both), the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin 420 or the skin 430 (or both), the non-woven fabric may comprise a thermoplastic material, a thermal setting binder, inorganic fibers, metal fibers, metallized inorganic fibers and metallized synthetic fibers. If desired, one or both of the skins 420, 430 may comprise a compounded flame retardant material or two or more different flame retardant materials, e.g., EG materials in combination with a Group II or Group III metal hydroxide. As noted herein, one or both of the skins 420, 430 may comprise an open cell structure or a closed cell structure.

In certain instances, an article can comprise a prepreg or core, at least one skin disposed on the prepreg or core and a decorative or cover layer disposed on the skin. Referring to FIG. 5, an article 500 is shown comprising a prepreg or core 510, a skin 520 disposed on a first surface of the prepreg or core 510 and a decorative layer 530 disposed on the skin 520. The prepreg or core 510 may comprise any of the materials described herein in connection with prepregs and cores, e.g., a thermoplastic material, reinforcing fibers and a compounded flame retardant material or two or more different flame retardant materials, e.g., EG materials in combination with a Group II or Group III metal hydroxide. The skin 520 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the prepreg or core 510. In other instances, the skin 520 may comprise a limiting oxygen index greater than about 22, as measured per ISO 4589 dated 1996. Where a thermoplastic film is present, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present, the coating may comprise at least one of unsaturated polyurethanes, vinyl esters, phenolics and epoxies. Where an inorganic coating is present, the inorganic coating may comprise minerals containing cations selected from Ca, Mg, Ba, Si, Zn, Ti and Al or may comprise at least one of gypsum, calcium carbonate and mortar. Where a non-woven fabric is present, the non-woven fabric may comprise a thermoplastic material, a thermal setting binder, inorganic fibers, metal fibers, metallized inorganic fibers and metallized synthetic fibers. The decorative layer 530 may be formed, e.g., from a thermoplastic film of polyvinyl chloride, polyolefins, thermoplastic polyesters, thermoplastic elastomers, or the like. The decorative layer 530 may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer 530 may also be produced using spunbond, thermal bonded, spun lace, melt-blown, wet-laid, and/or dry-laid processes. In some configurations, the skin 520 may comprise an open cell structure or a closed cell structure.

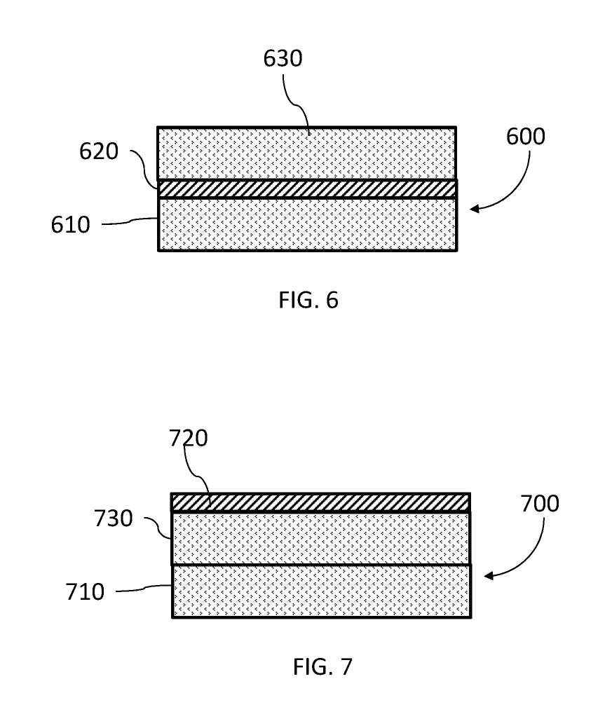

In certain configurations, two or more prepregs or cores can be coupled to each other through an intervening or intermediate layer such as, for example, a skin. Referring to FIG. 6, an article 600 comprising a prepreg or core 610 coupled to a prepreg or core 630 through an intermediate layer 620 is shown. Each of the prepregs or cores 610, 630 may be the same or may be different. In some instances, the thermoplastic materials and fibers of the prepregs or cores 610, 630 are the same, but the flame retardant material loading or type of flame retardant material present in the prepregs or cores 610, 630 is different. In other instances, the type and/or amount of flame retardant material in the prepregs or cores 610, 630 may be the same and one or both of the thermoplastic material and/or the fibers may be different, e.g., may be chemically different or may be present in different amounts. If desired, one or more suitable additional flame retardant agents, e.g., halogenated or non-halogenated flame retardant agents, EG materials in combination with a Group II or Group III metal hydroxide, compounded flame retardant materials, etc. may be present in one or both of the cores 610, 630. While the thickness of the prepregs or cores 610, 630 is shown as being about the same in FIG. 6, the thickness of the prepregs or cores 610, 630 can vary. Where an article comprising a “thick” core is desired, it may be desirable to couple two “thin” core layers to each other through skin layer 620. In some configurations, one of the prepregs or cores 610, 630 may comprise a lofting agent, e.g., microspheres. The intermediate layer 620 may take the form of a skin as described herein. The skin 620 desirably may comprise an open cell structure or a closed cell structure. For example, the intermediate layer 620 may comprise a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the prepreg or core 610. In other instances, the layer 620 may comprise a limiting oxygen index greater than about 22, as measured per ISO 4589 dated 1996. Where a thermoplastic film is present, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as or in the layer 620, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as or in the layer 620, the coating may comprise at least one of unsaturated polyurethanes, vinyl esters, phenolics and epoxies. Where an inorganic coating is present as or in the layer 620, the inorganic coating may comprise minerals containing cations selected from Ca, Mg, Ba, Si, Zn, Ti and Al or may comprise at least one of gypsum, calcium carbonate and mortar. Where a non-woven fabric is present as or in the layer 620, the non-woven fabric may comprise a thermoplastic material, a thermal setting binder, inorganic fibers, metal fibers, metallized inorganic fibers and metallized synthetic fibers. While not shown, a decorative layer can be coupled to either (or both) of the prepregs or cores 610, 630. As noted herein, the decorative layer may be formed, e.g., from a thermoplastic film of polyvinyl chloride, polyolefins, thermoplastic polyesters, thermoplastic elastomers, or the like. The decorative layer may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer may also be produced using spunbond, thermal bonded, spun lace, melt-blown, wet-laid, and/or dry-laid processes. If desired, the decorative layer may comprise a closed cell structure or an open cell structure.

In certain embodiments, two or more prepregs or cores can be coupled to each other and then a skin may be disposed on one surface of the prepregs or cores. Referring to FIG. 7, an article 700 comprising a prepreg or core 710 coupled to a prepreg or core 730 and a skin 720 disposed on the core 730 is shown. Each of the prepregs or cores 710, 720 may be the same or may be different. In some instances, the thermoplastic materials and fibers of the cores 710, 730 are the same, but the flame retardant material loading or type of flame retardant material present in the cores 710, 730 is different. In other instances, the type and/or amount of flame retardant material in the cores 710, 730 may be the same and one or both of the thermoplastic material and/or the fibers may be different, e.g., may be chemically different or may be present in different amounts. If desired, one or more suitable additional flame retardant agents, e.g., halogenated or non-halogenated flame retardant agents, EG materials in combination with a Group II or Group III metal hydroxide, compounded flame retardant materials, etc. may be present in one or both of the prepregs or cores 710, 730. While the thickness of the prepregs or cores 710, 730 is shown as being about the same in FIG. 7, the thickness of the prepregs or cores 710, 730 can vary. It may be desirable to build up a composite article using successive thin core layers to provide a desired overall core thickness. In some configurations, one of the prepregs or cores 710, 730 may comprise a lofting agent such as, for example, an expandable graphite material or microspheres or other materials. The skin 720 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the prepreg or core 730. In other instances, the skin 720 may comprise a limiting oxygen index greater than about 22, as measured per ISO 4589 dated 1996. Where a thermoplastic film is present as or in the skin 720, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as or in the skin 720, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as or in the skin 720, the coating may comprise at least one of unsaturated polyurethanes, vinyl esters, phenolics and epoxies. Where an inorganic coating is present as or in the skin 720, the inorganic coating may comprise minerals containing cations selected from Ca, Mg, Ba, Si, Zn, Ti and Al or may comprise at least one of gypsum, calcium carbonate and mortar. Where a non-woven fabric is present as or in the skin 720, the non-woven fabric may comprise a thermoplastic material, a thermal setting binder, inorganic fibers, metal fibers, metallized inorganic fibers and metallized synthetic fibers. Depending on the final configuration of the article 700, the skin 720 may be an open cell skin to permit sound energy to pass through the skin or may be a closed cell skin to reflect sound energy back into the cores 710, 730. While not shown, a decorative layer can be coupled to the skin 720 or to a surface of the prepreg or core 710. As noted herein, the decorative layer may be formed, e.g., from a thermoplastic film of polyvinyl chloride, polyolefins, thermoplastic polyesters, thermoplastic elastomers, or the like. The decorative layer may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer may also be produced using spunbond, thermal bonded, spun lace, melt-blown, wet-laid, and/or dry-laid processes.

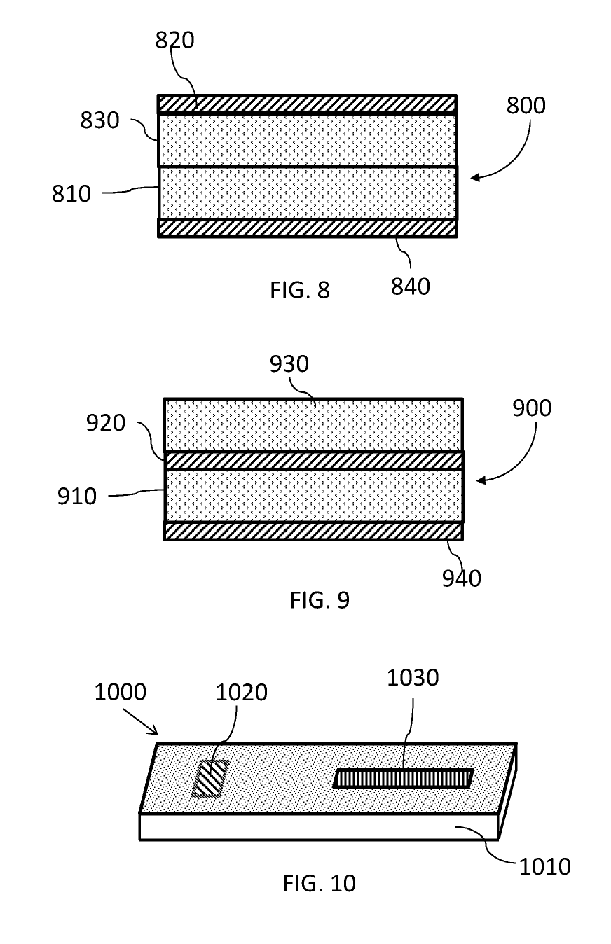

In certain embodiments, two or more prepregs or cores can be coupled to each other and then a skin may be disposed on each surface of the prepregs or cores. Referring to FIG. 8, an article 800 comprising a prepreg or core 810 coupled to a prepreg or core 830, a first skin 820 disposed on the core 830, and a second skin 840 disposed on the core 810 is shown. Each of the prepregs or cores 810, 830 may be the same or may be different. In some instances, the thermoplastic materials and fibers of the prepregs or cores 810, 830 are the same, but the flame retardant material loading or type of flame retardant material present in the prepregs or cores 810, 830 is different. In other instances, the type and/or amount of flame retardant material in the prepregs or cores 810, 830 may be the same and one or both of the thermoplastic material and/or the fibers may be different, e.g., may be chemically different or may be present in differ amounts. If desired, one or more suitable flame retardant agents, e.g., halogenated or non-halogenated flame retardant agents, EG materials in combination with a Group II or Group III metal hydroxide, compounded flame retardant materials, etc., may be present in one or both of the prepregs or cores 810, 830. While the thickness of the prepregs or cores 810, 830 is shown as being about the same in FIG. 8, the thickness of the prepregs or cores 810, 830 can vary. As noted herein, it may be desirable to use two or more core layers coupled to each other rather than a single core layer of increased thickness. In some configurations, one of the prepregs or cores 810, 830 may comprise a lofting agent such as expandable graphite material or microspheres or other materials. Each of the skins 820, 840 may independently comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the prepreg or core 830. In other instances, the skins 820, 840 may independently comprise a limiting oxygen index greater than about 22, as measured per ISO 4589 dated 1996. Where a thermoplastic film is present as or in the skin 820 or the skin 840 (or both), the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as or in the skin 820 or the skin 840 (or both), the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as or in the skin 820 or the skin 840 (or both), the coating may comprise at least one of unsaturated polyurethanes, vinyl esters, phenolics and epoxies. Where an inorganic coating is present as or in the skin 820 or the skin 840 (or both), the inorganic coating may comprise minerals containing cations selected from Ca, Mg, Ba, Si, Zn, Ti and Al or may comprise at least one of gypsum, calcium carbonate and mortar. Where a non-woven fabric is present as or in the skin 820 or the skin 840 (or both), the non-woven fabric may comprise a thermoplastic material, a thermal setting binder, inorganic fibers, metal fibers, metallized inorganic fibers and metallized synthetic fibers. If desired, one of the skins 820, 40 may independently comprise an open cell structure or a closed cell structure. While not shown, a decorative layer can be coupled to the skin 820 or to the skin 840 (or both). As noted herein, the decorative layer may be formed, e.g., from a thermoplastic film of polyvinyl chloride, polyolefins, thermoplastic polyesters, thermoplastic elastomers, or the like. The decorative layer may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer may also be produced using spunbond, thermal bonded, spun lace, melt-blown, wet-laid, and/or dry-laid processes.

In certain embodiments, two or more prepregs or cores can be coupled to each other through one or more skin layers. Referring to FIG. 9, an article 900 comprising a prepreg or core 910 coupled to a prepreg or core 930 through an intermediate layer 920, and a skin 940 disposed on the prepreg or core 910 is shown. If desired, the skin 940 can instead be disposed on the prepreg or core 930 or another skin (not shown) can be disposed on the prepreg or core 920. Each of the prepregs or cores 910, 930 may be the same or may be different. In some instances, the thermoplastic materials and fibers of the prepregs or cores 910, 930 are the same, but the flame retardant material loading or type of flame retardant material present in the prepregs or cores 910, 930 is different. In other instances, the type and/or amount of flame retardant material in the prepregs or cores 910, 930 may be the same and one or both of the thermoplastic material and/or the fibers may be different, e.g., may be chemically different or may be present in differ amounts. In certain instances, one or more suitable flame retardant agents, e.g., halogenated or non-halogenated flame retardant agents, EG materials in combination with a Group II or Group III metal hydroxide, compounded flame retardant materials, etc., may be present in one or both of the prepregs or cores 910, 930. While the thickness of the prepregs or cores 910, 930 is shown as being about the same in FIG. 9, the thickness of the prepregs or cores 910, 930 can vary. For example, two thin core layers can be coupled to each other instead of using a comparably thick single core layer. In some configurations, one or both of the prepregs or cores 910, 930 may comprise a lofting agent such an expandable graphite material or microspheres or other materials. In some configurations, the layer 920 and the skin 940 may independently comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the prepreg or core 830. In other instances, the layer 920 and the skin 940 may independently comprise a limiting oxygen index greater than about 22, as measured per ISO 4589 dated 1996. Where a thermoplastic film is present as or in the layer 920 or the skin 940 (or both), the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as or in the layer 920 or the skin 940 (or both), the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as or in the layer 920 or the skin 940 (or both), the coating may comprise at least one of unsaturated polyurethanes, vinyl esters, phenolics and epoxies. Where an inorganic coating is present as or in the layer 920 or the skin 940 (or both), the inorganic coating may comprise minerals containing cations selected from Ca, Mg, Ba, Si, Zn, Ti and Al or may comprise at least one of gypsum, calcium carbonate and mortar. Where a non-woven fabric is present as or in the layer 920 or the skin 940 (or both), the non-woven fabric may comprise a thermoplastic material, a thermal setting binder, inorganic fibers, metal fibers, metallized inorganic fibers and metallized synthetic fibers. In some instances, the skin 920 or the layer 940 may each independently comprise an open cell structure or a closed cell structures. While not shown, a decorative layer can be coupled to the skin 940 or the prepreg or core 930 (or both). As noted herein, the decorative layer may be formed, e.g., from a thermoplastic film of polyvinyl chloride, polyolefins, thermoplastic polyesters, thermoplastic elastomers, or the like. The decorative layer may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer may also be produced using spunbond, thermal bonded, spun lace, melt-blown, wet-laid, and/or dry-laid processes.

In certain embodiments, strips of materials can be disposed on a prepreg or core layer. Referring to FIG. 10, an article 1000 comprising a prepreg or core 1010 with strips 1020, 1030 disposed on different areas of the prepreg or core 1010 is shown. If desired, such strips can be present on any of the illustrative embodiments shown in FIGS. 1-9. The strips 1020, 1030 may be the same or may be different. In some instances, the strips 1020, 1030 may comprise compounded flame retardant material, EG material, EG materials in combination with a Group II or Group III metal hydroxide, etc., as noted herein. For example, the strips may comprise compounded flame retardant material comprising a thermoplastic material that can be melted to couple the strips to the prepreg or core 1010. In other instances, the strips may comprise EG material in combination with MDH or ATH (or both). In some instances, the strips 1020, 1030 may independently take the form of a prepreg or core as described herein. In other configurations, the strips may take the form of a skin or layer as described herein. In certain instances, the strips can be disposed, for example, on areas of the article 1000 where a differential thickness is desired. In other configurations, strips comprising compounded flame retardant material may be disposed at areas where increased or enhanced flame retardancy is desired.

In some embodiments, the prepregs and cores may include additional materials or additives to impart desired physical or chemical properties. It is a substantial attribute of using the flame retardant materials described herein that a non-colored or colored article can be produced. Where a non-colored article is produced, the article may then be colored or dyed to provide a desired color, texture, pattern, etc. For example, one or more dyes, texturizing agents, colorants, viscosity modifiers, smoke suppressants, synergistic materials, lofting agents, particles, powders, biocidal agents, foams or other materials can be mixed with or added to the prepregs or the cores to impart a desired color, texture or properties. In some instances, the prepregs or cores may comprise one or more smoke suppressant compositions in the amount of about 0.2 weight percent to about 10 weight percent. Illustrative smoke suppressant compositions include, but are not limited to, stannates, zinc borates, zinc molybdate, magnesium silicates, calcium zinc molybdate, calcium silicates, calcium hydroxides, and mixtures thereof. If desired, a synergist material can be present to enhance the physical properties of the prepregs or cores. For example, a synergist that enhances flame retardancy may be present.

In other instances, the prepregs or cores described herein may comprise a thermosetting material in a desired amount, e.g., in a minor amount less than about 50 weight percent based on the total weight of the prepreg or core, to impart desired properties to the core. The thermosetting material may be mixed with the thermoplastic material or may be added as a coating on one or more surfaces of the prepregs or cores.

In certain embodiments, the prepregs or cores described herein can be configured as (or used in) a glass mat thermoplastic composite (GMT) or a light weight reinforced thermoplastic (LWRT). One such LWRT is prepared by HANWHA AZDEL, Inc. and sold under the trademark SUPERLITE® material. SUPERLITE® mat loaded with flame retardant material can provide desirable attributed including, for example, flame retardancy and enhanced processing capabilities. The areal density of such a GMT or LWRT can range from about 300 grams per square meter (gsm) of the GMT or LWRT to about 4000 gsm, although the areal density may be less than 400 gsm or greater than 4000 gsm depending on the specific application needs. In some embodiments, the upper density can be less than about 4000 gsm. In certain instances, the GMT or the LWRT may comprise flame retardant material, e.g., EG materials in combination with a Group II or Group III metal hydroxide, compounded flame retardant materials, etc., disposed or present in void space of the porous GMT or the LWRT and/or on the fibers of the GMT or LWRT. Where a GMT or LWRT prepreg or core is used in combination with flame retardant material, the basis weight of the GMT or LWRT can be reduced to less than 800 gsm, 600 gsm or 400 gsm, for example, while still providing suitable flame retardant properties. In some examples, the overall thickness of the GMT or LWRT may be about 25 mm or less post lofting, 20 mm or less post lofting, greater than 3 mm pre-lofted or greater than 6 mm pre-lofted. In some instances, the pre-lofted thickness may be between about 3 mm and about 7 mm, and the post-lofted thickness may be between about 10 mm and about 25 mm.

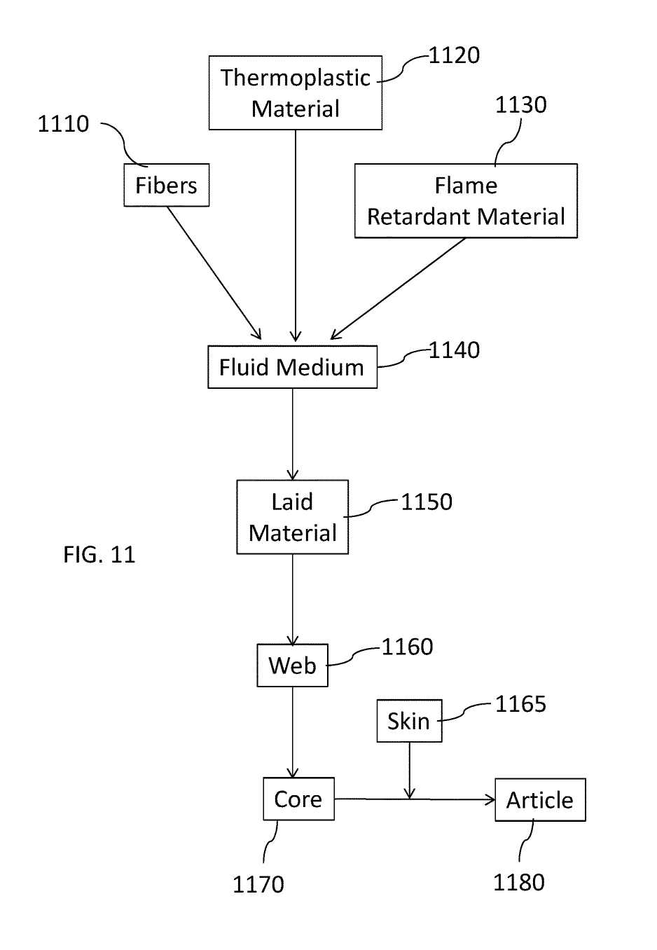

In producing the prepregs and cores described herein, it may be desirable to use a wet-laid process. A block diagram showing the process steps is present in FIG. 11. For example, a liquid or fluid medium 1140 comprising dispersed material, e.g., thermoplastic material 1120, fibers 1110 and flame retardant material 1130, e.g., EG materials in combination with a Group II or Group III metal hydroxide, compounded flame retardant materials, etc., optionally with any one or more additives described herein (e.g., other flame retardant agents), may be stirred or agitated in the presence of a gas, e.g., air or other gas. The dispersion may then be laid onto a support, e.g., a wire screen or other support material, to provide a substantially uniform distribution of the flame retardant material(s) in the laid down material 1150. To increase flame retardant material dispersion and/or uniformity, the stirred dispersion may comprise one or more active agents, e.g., anionic, cationic, or non-ionic such as, for example, those sold under the name ACE liquid by Industrial Soaps Ltd., that sold as TEXOFOR® FN 15 material, by Glover Chemicals Ltd., and those sold as AMINE Fb 19 material by Float-Ore Ltd. These agents can assist in dispersal of air in the liquid dispersion. The components can be added to a mixing tank, flotation cell or other suitable devices in the presence of air to provide the dispersion. While an aqueous dispersion is desirably used, one or more non-aqueous fluids may also be present to assist in dispersion, alter the viscosity of the fluid or otherwise impart a desired physical or chemical property to the dispersion or the prepreg, core or article.

In certain instances, after the dispersion has been mixed for a sufficient period, the fluid with the suspended materials can be disposed onto a screen, moving wire or other suitable support structure to provide a web of laid down material 1150. Suction or reduced pressure may be provided to the web to remove any liquid from laid down material to leave behind the thermoplastic material, the flame retardant material(s) and any other materials that are present, e.g., fibers, additives, etc. The resulting web 1160 can be dried and optionally consolidated or pressed to a desired thickness prior to fully forming it to provide a desired prepreg or core 1170. While wet laid processes may be used, depending on the nature of the thermoplastic material, the flame retardant material and other materials present, it may be desirable to instead use an air laid process, a dry blend process, a carding and needle process, or other known process that are employed for making non-woven products. In some instances, additional flame retardant materials can be sprayed onto the surface of the prepreg or core after the prepreg or core has hardened to some degree by passing the board underneath a plurality of coating jets that are configured to spray the flame retardant materials at about a ninety degree angle to the prepreg or core surface. In addition, one or more skins 1165 may be added to the core 1170 to provide an article 1180.

In some configurations, the prepregs and cores described herein can be produced by combining a thermoplastic material, fibers, flame retardant material(s), e.g., EG materials in combination with a Group II or Group III metal hydroxide, compounded flame retardant materials, etc., in the presence of a surfactant in an aqueous solution or foam. The combined components can be mixed or agitated for a sufficient time to disperse the various materials and provide a substantially homogeneous aqueous mixture of the materials. The dispersed mixture is then laid down on any suitable support structure, for example, a wire mesh or other mesh or support having a desired porosity. Water can then be evacuated through the wire mesh forming a web. The web is dried and heated above the softening temperature of the thermoplastic powder. The web is then cooled and pressed to a predetermined thickness to produce a composite sheet having a void content of between about 1 percent to about 95 percent. In an alternate embodiment, the aqueous foam also includes a binder material.

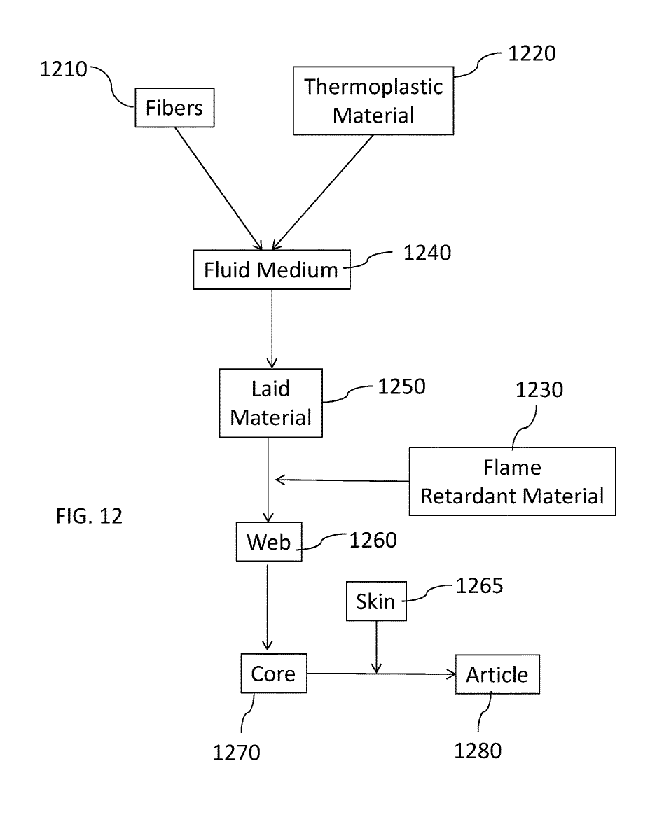

In other processes producing the articles, the flame retardant material may be coated or sprayed onto the prepreg subsequent to forming of the web. Where a compounded flame retardant material comprising a flame retardant material compounded with a thermoplastic material is used, spraying or coating of the compounded flame retardant material onto the heat prepreg can result in melting of the thermoplastic material of the compounded flame retardant material and loading of the prepreg with the flame retardant material. Where EG materials in combination with a Group II or Group III metal hydroxide are used, spraying or coating of the mixture onto the heated prepreg can result in formation of a surface layer and/or absorption of the mixture into the void space of the prepreg. Referring to FIG. 12, a process is shown where a liquid or fluid medium 1240 comprising dispersed material, e.g., thermoplastic material 1120 and fibers 1110 optionally with any one or more additives described herein, may be stirred or agitated in the presence of a gas, e.g., air or other gas. The dispersion 1240 may then be laid onto a support, e.g., a wire screen or other support material, to provide a laid down material 1250. To increase uniformity, the stirred dispersion may comprise one or more active agents, e.g., anionic, cationic, or non-ionic such as, for example, those sold under the name ACE liquid by Industrial Soaps Ltd., that sold as TEXOFOR® FN 15 material, by Glover Chemicals Ltd., and those sold as AMINE Fb 19 material by Float-Ore Ltd. These agents can assist in dispersal of air in the liquid dispersion. The components can be added to a mixing tank, flotation cell or other suitable devices in the presence of air to provide the dispersion. While an aqueous dispersion is desirably used, one or more non-aqueous fluids may also be present to assist in dispersion, alter the viscosity of the fluid or otherwise impart a desired physical or chemical property to the dispersion or the prepreg, core or article. In certain instances, after the dispersion has been mixed for a sufficient period, the fluid with the suspended materials can be disposed onto a screen, moving wire or other suitable support structure to provide a web of laid down material 1250. After laying down the material, flame retardant material 1230 may be added by spraying or coating the material onto the laid down material 1250 to provide a combined laid material. When the laid material 1250 with a sprayed compounded flame retardant material is heated, the thermoplastic material of the compounded flame retardant material and the thermoplastic material 1220 can melt and load the flame retardant material of the compounded flame retardant material into the laid material. Where EG materials in combination with a Group II or Group III metal hydroxide are used, melting of the thermoplastic material 1220 can permit the materials to occupy interior portions of the laid material and/or remain resident on the surface of the laid material. Alternatively, the flame retardant materials can be added after a web 1260 is formed. Suction or reduced pressure may be provided to the web 1260 to remove any liquid from laid down material to leave behind the thermoplastic material, the flame retardant materials and any other materials that are present, e.g., fibers, additives, etc. The resulting web 1260 can be dried and optionally consolidated or pressed to a desired thickness prior to fully forming it to provide a desired prepreg or core 1270. While wet laid processes may be used, depending on the nature of the thermoplastic material, the flame retardant material(s) and other materials present, it may be desirable to instead use an air laid process, a dry blend process, a carding and needle process, or other known process that are employed for making non-woven products. In some instances, additional flame retardant material can be sprayed onto the surface of the prepreg or core after the prepreg or core has hardened to some degree by passing the board underneath a plurality of coating jets that are configured to spray the compounded flame retardant material at about a ninety degree angle to the prepreg or core surface. In addition, one or more skins 1265 may be added to the core 1270 to provide an article 1280.

In certain examples, a prepreg or core in the form of a porous GMT can be produced. In certain instances, the GMT can be generally prepared using chopped glass fibers, a thermoplastic material, compounded flame retardant material and an optional thermoplastic polymer film or films and/or woven or non-woven fabrics made with glass fibers or thermoplastic resin fibers such as, for example, polypropylene (PP), polybutylene terephthalate (PBT), polyethylene terephthalate (PET), polycarbonate (PC), a blend of PC/PBT, or a blend of PC/PET. In some embodiments, a PP, a PBT, a PET, a PC/PET blend or a PC/PBT blend are can be used as the thermoplastic material. To produce the glass mat, a thermoplastic material, reinforcing materials, flame retardant material(s) and/or other additives can be added or metered into a dispersing foam contained in an open top mixing tank fitted with an impeller. Without wishing to be bound by any particular theory, the presence of trapped pockets of air of the foam can assist in dispersing the glass fibers, the thermoplastic material and the flame retardant materials. In some examples, the dispersed mixture of glass and resin can be pumped to a head-box located above a wire section of a paper machine via a distribution manifold. The foam, not the glass fiber, flame retardant material or thermoplastic, can then be removed as the dispersed mixture is provided to a moving wire screen using a vacuum, continuously producing a uniform, fibrous wet web. The wet web can be passed through a dryer at a suitable temperature to reduce moisture content and to melt or soften the thermoplastic material. When the hot web exits the dryer, a surface layer such as, for example, a film may be laminated onto the web by passing the web of glass fiber, flame retardant material, thermoplastic material and film through the nip of a set of heated rollers. If desired, additional layers such as, for example, a non-woven and/or woven fabric layer may also be attached along with the film to one side or to both sides of the web to facilitate ease of handling the glass fiber-reinforced mat. The composite can then be passed through tension rolls and continuously cut (guillotined) into the desired size for later forming into an end product article. Further information concerning the preparation of such GMT composites, including suitable materials and processing conditions used in forming such composites, are described, for example, in U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US2005/0228108, US 2005/0217932, US 2005/0215698, US 2005/0164023, and US 2005/0161865.

In certain instances, a method of producing a composite article comprises combining a thermoplastic material, reinforcing fibers and compounded flame retardant material in a mixture to form an agitated aqueous foam. The foam is disposed onto a wire support, and the water is evacuated to form a web or open cell structure comprising the thermoplastic material, fibers and compounded flame retardant materials. In some instances, the web is then heated to a first temperature above the melting temperature of the thermoplastic material. Where the compounded flame retardant material comprises a thermoplastic material compounded with a flame retardant material, the melting temperature may be selected so that both thermoplastic materials melt. If desired, the core may be compressed prior to fully forming to position the compounded flame retardant sheets closer to each other in the core layer. In some instances, pressure can then be applied to the web, e.g., using nip rollers or other devices, to provide a thermoplastic composite sheet comprising the flame retardant material from the compounded flame retardant material dispersed in the web.

In certain instances, a method of producing a composite article comprises combining a thermoplastic material, reinforcing fibers and a mixture of EG materials and a Group II or Group III metal hydroxide (such as MDH or ATH) in a mixture to form an agitated aqueous foam. The foam is disposed onto a wire support, and the water is evacuated to form a web or open cell structure comprising the thermoplastic material, fibers and EG materials/group II or group III metal hydroxide materials. In some instances, the web is then heated to a first temperature above the melting temperature of the thermoplastic material. If desired, the core may be compressed prior to fully forming to position the EG materials/group II or group III metal hydroxide materials closer to each other in the core layer. In some instances, pressure can then be applied to the web, e.g., using nip rollers or other devices, to provide a thermoplastic composite sheet comprising the flame retardant material from the EG materials/group II or group III metal hydroxide materials dispersed in the web.

In some embodiments, a composite article comprising a thermoplastic fiber-reinforced porous core layer and a skin disposed on at least one surface of the porous core layer, the porous core layer comprising a web formed from a plurality of reinforcing fibers, a compounded flame retardant material and a thermoplastic material, the composite article comprising an effective amount of the compounded flame retardant material to meet Class A requirements as tested by ASTM E84 dated 2009 can be used in settings such as office furniture, seating, etc. In some instances, the thermoplastic material comprises a polyolefin, the reinforcing fibers comprise glass fibers and the compounded flame retardant material comprises a group II metal hydroxide compounded with a polyolefin. In other examples, the glass fibers are present from about 30 to 60 weight percent, the compounded flame retardant material is present from about 30 weight percent to about 50 weight percent with the balance of the core layer comprising the thermoplastic material. If desired, the skin layer may be one or more of a scrim, an open-celled film or a closed cell film. In some instances, an adhesive layer may be present between the core layer and the skin layer. In certain embodiments, the article may comprise a second skin layer disposed on an opposite surface of the core layer. In some configurations, the core layer does not comprise any added flame retardant agent, e.g., the compounded flame retardant functions as a flame retardant agent but no additional flame retardant agents such as halogenated flame retardants are present. In certain examples, the article may comprise a first adhesive layer between the core layer and the skin layer and a second adhesive layer between the core layer and the second skin layer. In other examples, the article may comprise a decorative layer disposed on the skin layer. For example, in office applications it may be desirable to staple, glue or otherwise attach a fabric or covering to the article to provide for a more aesthetically pleasing article.

In certain examples, a non-molded composite article comprises a thermoplastic fiber-reinforced porous core layer and a skin disposed on at least one surface of the porous core layer, the porous core layer comprising a compressed web formed from a compounded flame retardant material and a plurality of reinforcing fibers held together by a thermoplastic material, the composite article comprising an effective amount of the compounded flame retardant material to meet Class A requirements as tested by ASTM E84 dated 2009 without molding of the composite article. In certain instances, the core layer does not comprise any added flame retardant materials, e.g., the compounded flame retardant functions as a flame retardant agent but no other flame retardant agents such as halogenated flame retardants are present in the core layer. In other examples, the article may comprise a lofting agent, e.g., microspheres. In certain instances, the skin is configured as an open cell scrim or a closed cell scrim. In certain examples, the article may comprise an additional skin disposed on an opposite surface of the core layer. In other embodiments, the additional skin is configured as a closed cell scrim or an open cell scrim.

In certain embodiments, a method of producing a thermoplastic composite article comprising a porous core layer comprising a plurality of reinforcing fibers, a thermoplastic material and compounded flame retardant material by heating the reinforcing fibers, the thermoplastic material and the compounded flame retardant material to a first temperature above a melting point of the thermoplastic material (or above the melting point of a thermoplastic material of the compounded flame retardant material where the compounded flame retardant material comprises a thermoplastic material compounded with a flame retardant material) to form a web comprising the thermoplastic material, the compounded flame retardant material and the reinforcing fibers, the thermoplastic composite article comprising an effective amount of the compounded flame retardant material to meet class A requirements as tested by ASTM E84 dated 2009. In certain embodiments, the method comprises using the thermoplastic composite article as a building panel without molding the thermoplastic composite article. In some instances, the method comprises compressing the core layer of the thermoplastic article, prior to forming of the core layer. In some examples, the method comprises configuring the thermoplastic composite article with a scrim on one surface of the thermoplastic composite article. In other embodiments, the method comprises configuring the thermoplastic composite article with an additional scrim on an opposite surface of the thermoplastic composite article, in which at least one of the scrim and the additional scrim comprises an open cell structure. In further examples, the method comprises configuring the porous core layer with about 35-55 weight percent glass fibers as the reinforcing fibers and at least 30 weight percent compounded flame retardant material with the balance of the porous core layer comprising the thermoplastic material.

In certain examples, a method comprises combining a first thermoplastic material, reinforcing fibers and compounded flame retardant material comprising a group II metal hydroxide compounded with a second thermoplastic material in a mixture to form an agitated aqueous foam, disposing the agitated aqueous foam onto a wire support, evacuating the water to form a web, heating the web to a first temperature at or above the melting temperature of the first thermoplastic material and the second thermoplastic material and compressing the web to a selected thickness, in which the thermoplastic composite article comprises an effective amount of the compounded flame retardant material to meet Class A requirements as tested by ASTM E84 dated 2009. In some examples, the compressing step comprises passing the heated web through a set of rollers. In some examples, the method may comprise mixing the agitated aqueous foam until the compounded flame retardant material is homogeneously dispersed in the agitated aqueous foam. In other instances, the method may comprise applying a scrim to at least one surface of the thermoplastic composite article prior to compressing the article. In some instances, the method may comprise applying a scrim to at least one surface of the thermoplastic composite article after compressing the article. In some instances, the method may comprise coupling the thermoplastic article to a second thermoplastic article comprising substantially the same composition and a different thickness as the thermoplastic article.

Certain examples are described below to illustrate better some of the novel aspects and configurations described herein.

### EXAMPLE 1

Virgin polypropylene (PP), glass fibers and magnesium hydroxide (MDH) compounded with polypropylene (MDH:PP ratio of 7:3) was used to prepare a dispersion. The dispersion included adding about 40 weight percent MDH:PP into a mixture comprising 60 weight percent glass fibers and 40 weight percent PP. The mixture was stirred using a mixing tank and laid down onto a wire screen. Suction was applied to remove the liquid leaving behind the three components. The web was heated to melt the PP materials. After heating, the web was permitted to cool and formed a white board. The board was tested according to the protocol specified in ASTM E84 dated 2009. The board met the class A standard under the ASTM E84 test.

### EXAMPLE 2

Virgin polypropylene (PP), glass fibers, magnesium hydroxide (MDH) and expandable graphite material (Asbury 3335 EG) was used to prepare a dispersion. The dispersion included about 3 weight percent EG, varying amounts of MDH (see table 1 below), about 38 to 44 weight percent glass fibers with the balance weight percent (45-55 weight percent) being PP depending on the exact amount of flame retardant materials present. Each mixture was stirred using a mixing tank and laid down onto a wire screen. Suction was applied to remove the liquid leaving behind the four components. The web was heated to melt the PP. After heating, the web was permitted to cool and formed a board. Each board with differing amounts of MDH was molded to a thickness of about 6 mm. The overall basis weight of the boards was about 1200 gsm.

Table 1 below shows the results of a SAE self-extinguishing (SE) flammability Test (as measured using SAE J369 REV. No. 2007).

TABLE 1

| Sample | EG % | MDH % | Non-oil SAE SE | Oil-soaked SAE SE |
|---|---|---|---|---|
| 1 | 3 | 0 | No | Yes |
| 2 | 3 | 1.5 | No | Yes |
| 3 | 3 | 3 | No | Yes |
| 4 | 3 | 6 | No | Yes |
| 5 | 3 | 9 | Yes | Yes |
| 6 | 3 | 12 | Yes | Yes |

The results are consistent with the presence of MDH permitting a reduction in EG levels while still passing the SAEJ369 test for both non-oil and oil soaked samples. For example, about 9 weight percent MDH when used in combination with 3 weight percent EG permits the board to meet the SAE F369 flammability test. In contrast, for non-oil soaked samples, EG levels significantly higher than 3 weight percent are needed, e.g., 10 weight percent or higher, to pass the SAEJ369 test, which increases overall cost and production complexity when higher levels of EG materials are used.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A thermoplastic composite article comprising a porous core layer comprising a plurality of reinforcing fibers, a thermoplastic material, and a compounded flame retardant material.

2. The thermoplastic composite article of claim 1, in which the compounded flame retardant material comprises a hydroxide material compounded with a thermoplastic material.

3. The thermoplastic composite article of claim 2, in which the hydroxide material comprises a group II metal hydroxide, and wherein the compounded flame retardant material is present in an effective amount for the article to meet a Class A standard as tested by ASTM E84.

4. The thermoplastic composite article of claim 3, in which the thermoplastic material of the compounded flame retardant material comprises a common thermoplastic material as present in the porous core layer.

5. The thermoplastic composite article of claim 3, in which the thermoplastic material of each of the porous core layer and the compounded flame retardant is independently selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

6. The thermoplastic composite article of claim 3, in which the thermoplastic material of the compounded flame retardant material comprises a different thermoplastic material from the thermoplastic material.

7. The thermoplastic composite article of claim 6, in which the thermoplastic material of each of the porous core layer and the compounded flame retardant is independently selected from the group consisting of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof, wherein the thermoplastic material selected for the thermoplastic material of the core layer is different than the thermoplastic material present in the compounded flame retardant material.

8. The thermoplastic composite article of claim 1, in which the porous core layer provides flame retardancy and is halogen free.

9. The thermoplastic composite article of claim 8, further comprising a flame retardant agent in the porous core layer, in which the flame retardant agent comprises at least one of N, P, As, Sb, Bi, S, Se, or Te.

10. The thermoplastic composite article of claim 1, further comprising a lofting agent in the porous core layer.

11. A thermoplastic composite article comprising a porous core layer comprising a web of open cell structures comprising random crossing over of reinforcing fibers held together by a first thermoplastic material and a second thermoplastic material from a compounded flame retardant material comprising the second thermoplastic material and a flame retardant material.

12. The thermoplastic composite article of claim 11, in which the compounded flame retardant material comprises a hydroxide material compounded with the second thermoplastic material.

13. The thermoplastic composite article of claim 12, in which the hydroxide material comprises a group II metal hydroxide, and wherein the compounded flame retardant material is present in an effective amount for the article to meet a Class A standard as tested by ASTM E84.

14. The thermoplastic composite article of claim 13, in which the second thermoplastic material of the compounded flame retardant material comprises the same thermoplastic material as the first thermoplastic material.

15. The thermoplastic composite article of claim 11, in which the first thermoplastic material and the second thermoplastic material independently comprise at least one of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

16. The thermoplastic composite article of claim 13, in which the first thermoplastic material and the second thermoplastic material comprise different thermoplastic materials.

17. The thermoplastic composite article of claim 11, in which the plurality of reinforcing fibers comprise at least one of glass fibers, aramid fibers, graphite fibers, carbon fibcrs, inorganic mineral fibers, metal fibers, metalized synthetic fibers, and metallized inorganic fibers.

18. The thermoplastic composite article of claim 11, in which the porous core layer provides flame retardancy and is halogen free.

19. The thermoplastic composite article of claim 18, further comprising an additional flame retardant agent comprises at least one of N, P, As, Sb, Bi, S, Se, or Te.

20. The thermoplastic composite article of claim 11, further comprising a lofting agent in the porous core layer.

21-194. (canceled)
